(19) United States
(12) Patent Application Publication
(10) Pub. No.: US 2026/0277971 A1
(43) Pub. Date: Sep. 17, 2026

(54) TECHNIQUES FOR ROUTING QUERIES IN MULTI-BACKEND ARTIFICIAL INTELLIGENCE SYSTEMS

(71) Applicant: NVIDIA Corporation, Santa Clara, CA (US)

(72) Inventors: Ronald Isaac, San Ramon, CA (US); Somnath Devidas Kopnar, Pune (IN); Anjul Patney, Redmond, WA (US); Deep Shekhar, Bangalore (IN); Ram Rangan, Chennai (IN)

(21) Appl. No.: 19/090,268

(22) Filed: Mar. 25, 2025

(30) Foreign Application Priority Data
Mar. 17, 2025 (IN) 202511023451

(51) Int. Cl. G06F 16/334

(52) U.S. Cl. CPC G06F 16/3347

(57) ABSTRACT

In various examples, techniques for routing queries in multi-backend artificial intelligence systems is described herein. Systems and methods described herein may include a frontend that uses various routing techniques to select backends for routing queries. For instance, the frontend may use at least a keyword routing technique that routes queries to backends based at least on identifiers (e.g., names, codenames, etc.) included in the queries, a classification routing technique that routes queries to backends based at least on performing text classification (e.g., using one or more models, embedding comparisons, etc.), and/or a serialized routing technique that routes queries to backends based at least on an order (e.g., either static or dynamic). In some examples, the backends may be configured to initially respond to the frontend to indicate whether the backends accept or reject queries, such that the frontend is able to reroute queries if needed.

### CROSS-REFERENCE TO RELATED APPLICATIONS

This application claims priority to Indian Patent Application number 202511023451, filed Mar. 17, 2025, which has hereby incorporated by reference in its entirety.

### BACKGROUND

Artificial intelligence (AI) systems are increasing in complexity by including multiple independent AI agents under a unified user interface to meet desired functional goals and user experience demands. In these AI systems, the individual AI agents become independent backends to the user interface's frontend. For example, a gaming AI system may include at least a first backend that operates an AI assistant for tuning system parameters and a second backend that operates an AI assistant for providing gaming advice, where both backends operate with respect a frontend that operates a unified user interface. For these AI systems to operate, a frontend converts natural language queries—such as typed or spoken inputs from users—to textual formats which are then routed to the backends capable of processing the queries. As such, it is important for these AI systems to accurately and/or efficiently route of the natural language queries to the correct backends for processing.

### SUMMARY

Embodiments of the present disclosure relate to techniques for routing queries in multi-backend artificial intelligence systems. Systems and methods described herein may include a frontend that uses various routing techniques to select backends for routing queries. For instance, the frontend may use at least a keyword routing technique that routes queries to backends based at least on identifiers (e.g., names, codenames, etc.) included in the queries, a classification routing technique that routes queries to backends based at least on performing text classification (e.g., using one or more models, embedding comparisons, etc.), and/or a serialized routing technique that routes queries to backends based at least on an order (e.g., either static or dynamic). In some examples, the backends may be configured to initially respond to the frontend to indicate whether the backends accept or reject queries, such that the frontend is able to reroute queries if needed.

In contrast to conventional systems, the systems of the present disclosure, in some embodiments, use the various routing techniques to route the queries to the backends. This may increase the accuracy and/or efficiency of the systems of the present disclosure by more quickly routing the queries to the correct backends that are able to process the queries and perform requested tasks. Additionally, in some examples, by using these various routing techniques, the systems of the present disclosure are able to route individual queries to a single backend rather than having to route the queries to multiple backends. This may save computing resources as routing queries to multiple backends requires network resources to send the queries and/or processing resources to process the queries by each of the backends.

### BRIEF DESCRIPTION OF THE DRAWINGS

The present systems and methods for techniques for routing queries in multi-backend artificial intelligence systems are described in detail below with reference to the attached drawing figures, wherein:

FIG. 1 illustrates an example data flow diagram for a process for routing queries in a multi-backend system, in accordance with some embodiments of the present disclosure;

FIGS. 2A-2B illustrate an example of using a keyword routing technique to determine backends for routing queries, in accordance with some embodiments of the present disclosure;

FIG. 3A illustrates an example of a process for training one or more models to classify queries for routing to backends, in accordance with some embodiments of the present disclosure;

FIGS. 3B-3C illustrate examples of using one or more models to classify queries for routing to backends, in accordance with some embodiments of the present disclosure;

FIGS. 4A-4B illustrate an example of using a classification routing technique to determine backends for routing queries, in accordance with some embodiments of the present disclosure;

FIG. 5 illustrates an example of using one or more language models to generate queries associated with backends, in accordance with some embodiments of the present disclosure;

FIG. 6 illustrates an example of using a serialized routing technique to determine backends for routing queries, in accordance with some embodiments of the present disclosure;

FIG. 7 illustrates an example of routing a query to different backends for processing, in accordance with some embodiments of the present disclosure;

FIG. 8 illustrates a flow diagram showing a method for routing a query in a multi-backend artificial intelligence system, in accordance with some embodiments of the present disclosure;

FIG. 9 illustrates a flow diagram showing a method for using multiple routing techniques to route queries to backends, in accordance with some embodiments of the present disclosure;

FIG. 10A is a block diagram of an example generative language model system suitable for use in implementing at least some embodiments of the present disclosure;

FIG. 10B is a block diagram of an example generative language model that includes a transformer encoder-decoder suitable for use in implementing at least some embodiments of the present disclosure;

FIG. 10C is a block diagram of an example generative language model that includes a decoder-only transformer architecture suitable for use in implementing at least some embodiments of the present disclosure;

FIG. 11 is a block diagram of an example computing device suitable for use in implementing some embodiments of the present disclosure; and

FIG. 12 is a block diagram of an example data center suitable for use in implementing some embodiments of the present disclosure.

### DETAILED DESCRIPTION

Systems and methods are disclosed for techniques for routing queries in multi-backend artificial intelligence systems. For instance, a system(s) may include a frontend that receives input data representing a query. As described herein, the input data may include, but is not limited to, audio data representing speech corresponding to the query, text data representing text describing the query, selection data representing one or more selections associated with the query, image data representing one or more images of a user gesturing the query, and/or any other type of input data. In some examples, the frontend may then process at least a portion of the query to generate text corresponding to the query. For example, if the input data includes audio data representing speech, then the frontend may process the audio data using one or more speech processing components—such as an automatic speech recognition (ASR) model, a natural language processing (NLP) model, and/or the like—to generate the text corresponding to the query.

The system(s) may further include multiple backends that are capable of processing queries. As described herein, a backend may use one or more processing components to process queries, where a processing component may include a model (e.g., a language model, a classification model, a vision model, etc.), a neural network, a classifier, a software program, a software application, a processor, a module, an algorithm, and/or any other type of processing component. Additionally, different backends may be configured to perform different types of processing with respect to queries. For example, the system(s) may include a first backend that includes an AI agent to respond to general speech queries, a second backend that includes an AI agent to response to specific speech queries (e.g., gaming queries), a third backend that includes an AI agent to control system parameters, a fourth backend that includes an AI agent to retrieve content for output, and/or any other type of backend.

As such, the frontend may use one or more routing techniques to determine which backend to route the query for processing. For instance, in some examples, the frontend may use a first routing technique—which may also be referred to as a “keyword routing technique”—to determine a backend based at least on specific text from the query. To perform the keyword routing technique, the frontend may store mapping data that maps identifiers with respect to the backends. As described herein, an identifier may include, but is not limited to, a name, a codename, an alphabetic identifier, a numerical identifier, an alphanumeric identifier, and/or any other type of identifier that may be used to identify a backend. As such, to determine a backend to route a query, the frontend may process the text corresponding to the query to identify an identifier included in the text. The frontend may then use the mapping data to determine that the identifier maps to one of the backends and, as such, determine to route the query to the backend.

In some examples, when performing the keyword routing technique, the frontend may use additional information to route the queries, such as one or more previously received and/or routed queries. For example, the frontend may receive an initial query that includes an identifier of a backend. As such, the frontend may use one or more of the processes described herein to determine to route the initial query to the backend. Additionally, based on the initial query including the identifier and/or the initial query being routed to the backend, the frontend may continue determining to route new queries to the same backend if the new queries do not include identifiers of other backends. The frontend may then continue to perform these processes of determining to route the queries to the backend until receiving another query that includes an identifier of another backend. In other words, the frontend will change backends for routing queries when receiving queries that identify the new backends.

Additionally, or alternatively, in some examples, the frontend may use a second routing technique—which may also be referred to as a “classification routing technique”—to determine a backend based at least on classifying the query. A first implementation of the classification routing technique may include using one or more language models to process the text and output data indicating a classification associated with routing the query. In some examples, the language model(s) may be fine-tuned to classify queries, such as by training the language model(s) using queries specific to the different types of backends. Additionally, a second implementation of the classification routing technique may include using one or more neural networks to process the text and output data indicating a classification associated with the query. For instance, the neural network(s) may be trained to classify queries for the specific backends. Still, a third implementation of the classification routing technique may include using a retrieval-augmented generation (RAG) system to classify the query.

For instance, the frontend may include one or more databases that store at least queries associated with the backends. In some examples, the frontend may include an individual database for each backend, where a database then stores queries that may be processed by a specific backend. Additionally, or alternatively, in some examples, the frontend may include a single database that stores queries that may be processed by multiple backends. In any of the examples, a database may store at least the queries, classification information that relates the queries to the backend(s), and/or vectors (e.g., embeddings) associated with the queries. Additionally, and as described in more detail herein, the queries for the database(s) may be generated using one or more techniques, such as by using one or more language models, information relevant to the backend(s), a history of queries, and/or the like.

To classify a query using the database(s), the frontend may initially process the text using one or more processing components—such as a text embedder, an algorithm, a model, and/or the like—to generate a vector (e.g., an embedding) associated with the query. The frontend may then compare the vector to the vectors stored in the database(s)—such as by taking the inner products between the vectors, the dot products between the vectors, the Euclidean distances between the vectors, the cosine similarities between the vectors, and/or the like—to determine scores representing similarities between the query and the stored queries in the database(s). Additionally, the frontend may use the scores to classify the query as being associated with one of the backends.

For instance, in some examples, the frontend may classify the query as being associated with a backend for which a highest scoring query is also classified. Additionally, or alternatively, in some examples, the frontend may initially use the scores to determine final scores associated with the backends, such as based on the averages of the scores associated with the different backends. The frontend may then classify the query as being associated with the backend corresponding to the highest final score. Additionally, or alternatively, in some examples, the frontend may use a portion of the scores to determine final scores associated with the backends, such as by weighing the scores. For example, the frontend may determine the final scores using the five highest scores associated with the individual backends. The frontend may then again classify the query as being associated with the backend corresponding to the highest final score. While these are just three example techniques for how the frontend may use the scores to classify the query, in other examples, the frontend may use additional and/or alternative techniques.

Additionally, or alternatively, in some examples, the frontend may use a third routing technique—which may also be referred to as a “serialized routing technique”—to determine a backend based at least on an order. For instance, the order may indicate a first backend, followed by a second backend, followed by a third backend, and/or so forth. In some examples, the order may include a static order which may not change over a period of time. However, in some examples, the order may include a dynamic order that changes over a period of time. For example, the frontend may update the order based on one or more factors, such as how often the backends are used to process queries, programs and/or applications being executed, which backend operating system process is in the foreground and/or which backend operating system process is in the background, user preferences, user history, information from an operating system scheduler, and/or any other factors. In other words, the frontend may update the order such that the most likely backend for processing queries is first, followed by the second most likely backend, followed by the third most likely backend, and/or so forth.

After determining a backend using one or more of the techniques described herein, the frontend may then route at least a portion of the input data to the backend. In some examples, the backend may then process the input data—such as by using an AI agent—to perform a task. For example, the backend may generate output data associated with the query (e.g., a response to the query), provide content associated with the query, update one or more systems parameters, and/or perform any other type of action. Additionally, in some examples, the frontend may provide one or more outputs to a user that provided the query. For a first example, if the query includes a request for information, then the frontend may receive output data representing a response to the query from the backend and provide the response to the user. For a second example, if the query includes a request for content, such as images, then the frontend may receive content data representing the content from the backend and provide the content to the user.

However, in some examples, the backend may be unable to process and/or respond to the query. For example, the frontend may determine the wrong backend associated with the query. In such examples, the frontend may receive an indication from the backend that the backend is unable to process the query (e.g., the backend has rejected the query). In response, the frontend may determine another backend to route the query, such as by using one or more of the routing techniques described herein. For a first example, the frontend may use the classification routing technique to again classify the query using another backend. For a second example, the frontend may use the serialized routing technique to determine the second backend that is after the initial backend in the order. In either of the examples, the frontend may then route at least a portion of the input data to the other backend. In some examples, these processes may then continue to repeat until the frontend identifies a backend that is capable of processing the input data.

While the examples above describe using a single routing technique to route the query, in other examples, the frontend may use more than one routing technique. For instance, the frontend may use a first routing technique—such as the classification routing technique—to determine a first backend and a second routing technique—such as the serialized routing technique—to determine a second backend. The frontend may then use both determinations to determine a final backend for routing the query. For example, if the first backend is the same as the second backend, then the frontend may determine to route the query to that backend. However, if the first backend is different than the second backend, then the frontend may determine one of the backends for routing the query. For instance, and as described in more detail herein, the frontend may determine to use the first backend since the first routing technique is given priority over the second routing technique.

Additionally, while the examples above describe routing the query to a single backend, in other examples, the frontend may determine multiple backends for routing the query. For a first example, the frontend may use a routing technique to determine two different backends for routing the query. For a second example, the frontend may use a first routing technique to determine a first backend and a second routing technique to determine a second backend for routing the query. In either of the examples, the frontend may route the input data representing the query to both of the backends such that at least one of the backends is able to process the query to perform at least one task.

In some examples, the mode(s) (e.g., machine learning models, deep neural networks, language models, LLMs, SLMs, VLMs, multi-modal language models, perception models, tracking models, fusion models, transformer models, diffusion models, encoder-only models, decoder-only models, encoder-decoder models, neural rendering field (NERF) models, neural networks, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure.

For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing large language models (LLMs), systems implementing small language models (SLMs), systems implementing one or more vision language models (VLMs), systems implementing one or more multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

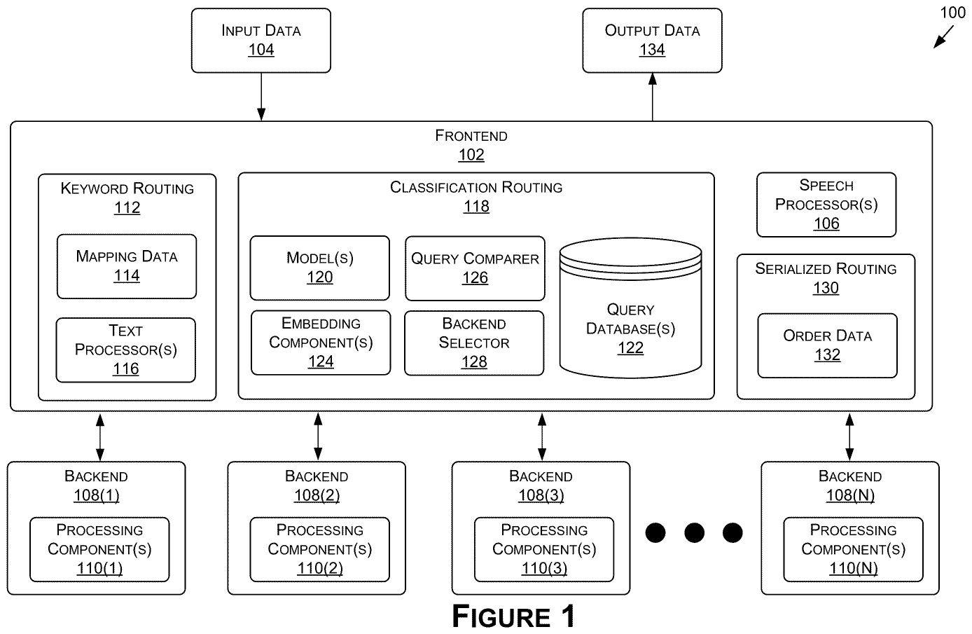

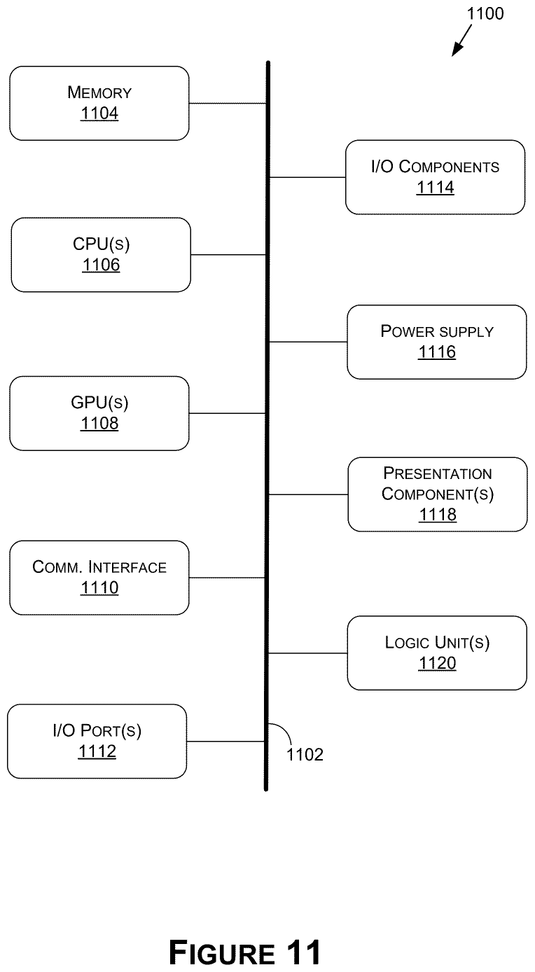

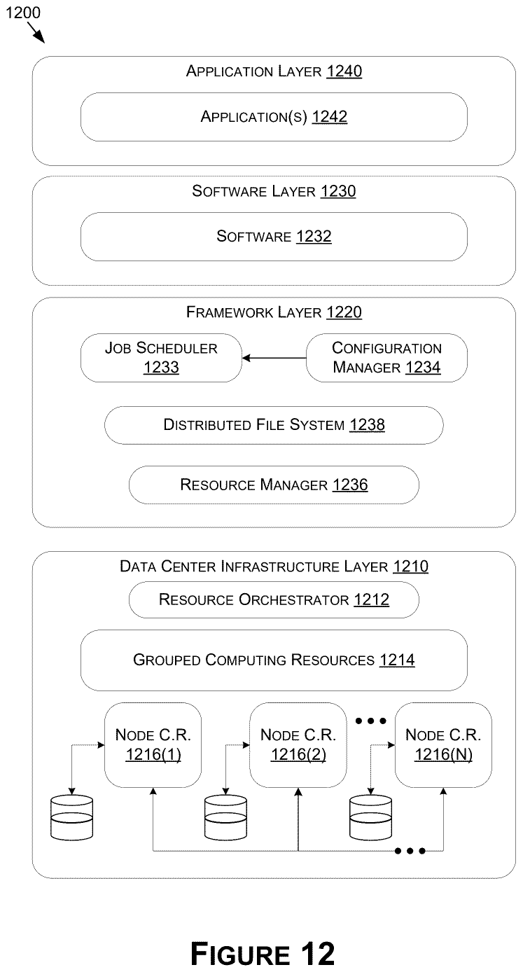

With reference to FIG. 1, FIG. 1 illustrates an example data flow diagram for a process 100 for routing queries in a multi-backend system, in accordance with some embodiments of the present disclosure. If should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example computing device 1100 of FIG. 11 and/or example data center 1200 of FIG. 12.

For instance, the process 100 may include using a frontend 102 to receive input data 104 representing at least queries. As described herein, input data 104 may include, but is not limited to, audio data representing speech corresponding to a query, text data representing text describing the query, selection data representing one or more selections associated with the query, image data representing one or more images of a user gesturing the query, and/or any other type of input data. Additionally, a query may include, but is not limited to, a request for information, a request to perform an action, a request for receiving content, a request to output content, and/or any other type of query associated with performing any type of action.

In some examples, the frontend 102 may then use one or more speech processors 106 to process at least a portion of the input data 104 to generate text data representing text corresponding to the query. For instance, if input data 104 includes audio data representing speech, then the speech processor(s) 106 may be configured to process the audio data and generate text data representing text corresponding to the speech. As described herein, a speech processor 106 may include, but is not limited to, an ASR model, a NLP model, and/or any other type of processing component that is configured to perform at least a portion of the processing described herein. Additionally, the text may include letters, numbers, words, punctuation, symbols, and/or any other type of text.

The process 100 may then include the frontend 102 using one or more routing techniques to determine which backends 108(1)-(N) (also referred to singularly as “backend 108” or in plural as “backends 108”) to route queries. As shown, the backends 108 may include processing components 110(1)-(N) (also referred to singularly as “processing component 110” or in plural as “processing components 110”) that the backends 108 use to process queries in order to perform various tasks. For instance, a processing component 110 may include, but is not limited to, a model (e.g., a language model, a classification model, a vision model, etc.), a neural network, a classifier, a software program, a software application, a processor, a module, an algorithm, and/or any other type of processing component. Additionally, different backends 108 may be configured to perform different types of processing with respect to queries. For example, the first backend 108(1) may include an AI agent that responds to general speech queries, the second backend 108(2) may include an AI agent that responds to specific speech queries (e.g., gaming queries), the third backend 108(3) may include an AI agent that control system parameters, and the last backend 108(N) may include an AI agent that retrieves and/or provides content.

To route a query, in some examples, the frontend 102 may use a keyword routing technique 112 to determine a backend 108 based at least on specific text from the query. To perform the keyword routing technique 112, the frontend 102 may store mapping data 114 that maps identifiers with the backends 108. As described herein, an identifier may include, but is not limited to, a name, a codename, an alphabetic identifier, a numerical identifier, an alphanumeric identifier, and/or any other type of identifier that may be used to identify a backend 108. The frontend 102 may then use one or more text processors 116 to determine whether the text corresponding to the query includes an identifier from the mapping data 114. As described herein, a text processor 116 may include, but is not limited to, a model, a neural network, a classifier, a software program, a software application, a processor, a module, an algorithm, and/or any other type of processing component. If the text processor(s) 116 determines that the text includes an identifier, then the frontend 102 may further use the mapping data 114 to identify the corresponding backend 108 for routing the query.

In some examples, when performing the keyword routing technique 112, the frontend 102 may use additional information to route queries, such as one or more previously received and/or routed queries. For example, the frontend 102 may receive an initial query that includes an identifier of a backend 108. As such, the frontend 102 may use one or more of the processes described herein to determine to route the initial query to the backend 108. Additionally, based on the initial query including the identifier and/or the initial query being routed to the backend 108, the frontend 102 may continue determining to route new queries to the same backend 108 if the new queries do not include identifiers of other backends 108. The frontend 102 may then continue to perform these processes of determining to route the queries to the backend 108 until receiving another query that includes an identifier of another backend 108. In other words, the frontend 102 will change backends 108 for routing queries when receiving queries that identify the new backends 108.

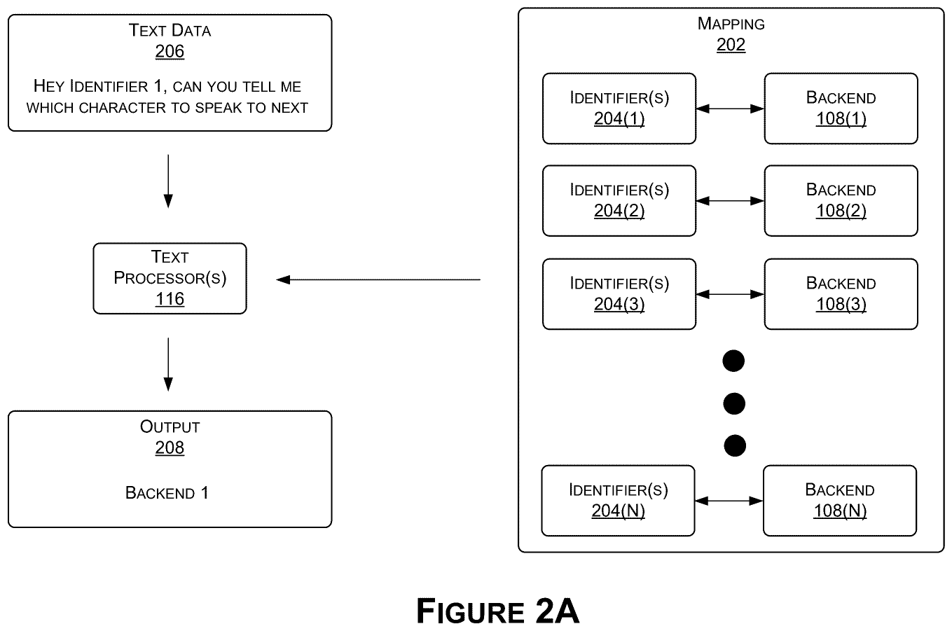

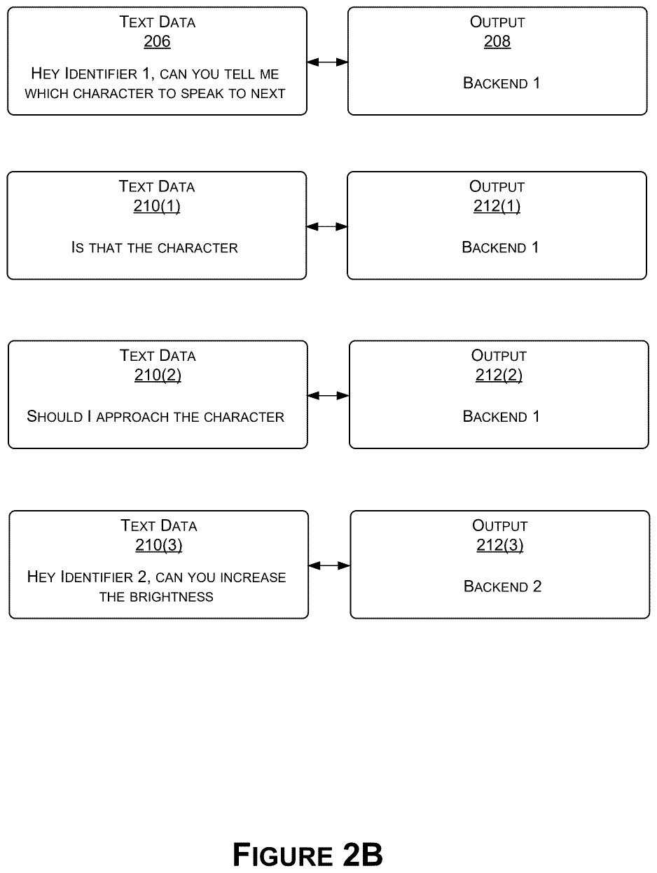

For more details, FIGS. 2A-2B illustrate an example of using the keyword routing technique 112 to determine backends 108 for routing queries, in accordance with some embodiments of the present disclosure. As shown by the example of FIG. 2A, the frontend 102 may use a mapping 202 (which may be represented by the mapping data 114) that associates identifiers 204(1)-(N) (also referred to singularly as “identifier 204” or in plural as “identifiers 204”) with the backends 108. For instance, the mapping 202 may associate the first backend 108(1) with the first identifier(s) 204(1), the second backend 108(2) with the second identifier(s) 204(2), and/or so forth. In some examples, the mapping 202 may include additional information associated with the backends 108, such as the types of processing tasks that are performed by the backends 108. This way, the frontend 102 may use the mapping 202 to provide one or more users with the identifiers 204 for the different backends 108 along with the processing tasks that the backends 108 are able to perform.

The frontend 102 may then process input data to generate text data 206 representing text corresponding to a query. As shown, the text processor(s) 116 may analyze the text to determine that the query includes an identifier of a backend 108—such as “Identifier 1”—and/or that the query includes a keyword “Hey” followed by the identifier of the backend 108. For instance, the keyword may indicate that the following portion of the query is going to include the identifier of the backend 108. The text processor(s) 116 may then analyze the mapping 202 to determine that the identifier from the query matches one of the first identifier(s) 204(1). Additionally, based on that determination, the text processor(s) 116 may generate an output 208 indicating that the first backend 108(1) is referenced by the query which the frontend 102 uses to determine to route the query to the first backend 108(1).

As shown by the example of FIG. 2B, the frontend 102 may then generate text data 210(1)-(3) representing text corresponding to new queries received over a period of time. The text processor(s) 116 may analyze the text represented by the text data 210(1) to determine that the second query does not include a new identifier of a backend 108. As such, the text processor(s) 116 may generate an output 212(1) indicating that the first backend 108(1) was the last backend 108 referenced, where the frontend 102 uses the output 212(1) to determine to route the second query to the first backend 108(1). Additionally, text processor(s) 116 may analyze the text represented by the text data 210(2) to determine that the third query also does not include a new identifier of a backend 108. As such, the text processor(s) 116 may generate an output 212(2) indicating that the first backend 108(1) was the last backend 108 referenced, where the frontend 102 uses the output 212(2) to determine to route the third query to the first backend 108(1). Furthermore, the text processor(s) 116 may analyze the text represented by the text data 210(3) to determine that the fourth query includes a new identifier—such as “Identifier 2”—associated with the second backend 108(2). As such, the text processor(s) 116 may generate an output 212(3) indicating that the second backend 108(2) is referenced by the fourth query, where the frontend 102 uses the output 212(3) to determine to route the fourth query to the second backend 108(2).

As such, by performing such processes, the frontend 102 may provide the user with the identifiers 204 associated with the backends 108 and/or the processing tasks that the backends 108 are able to perform. The user may then expressly identify which backends 108 the user wants to process queries, where the frontend 102 uses the express identifiers to determine the backends 108 for routing the queries. Additionally, the user may not need to expressly identify the same backend 108 when multiple subsequent queries are directed to the backend 108, but only when the user wants to direct a new query to a new backend 108 for processing.

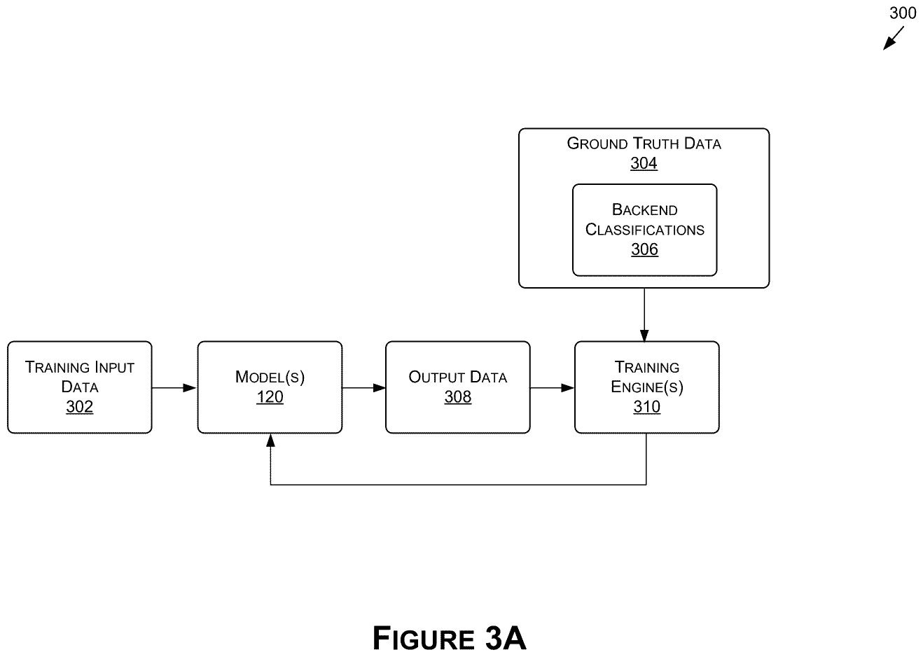

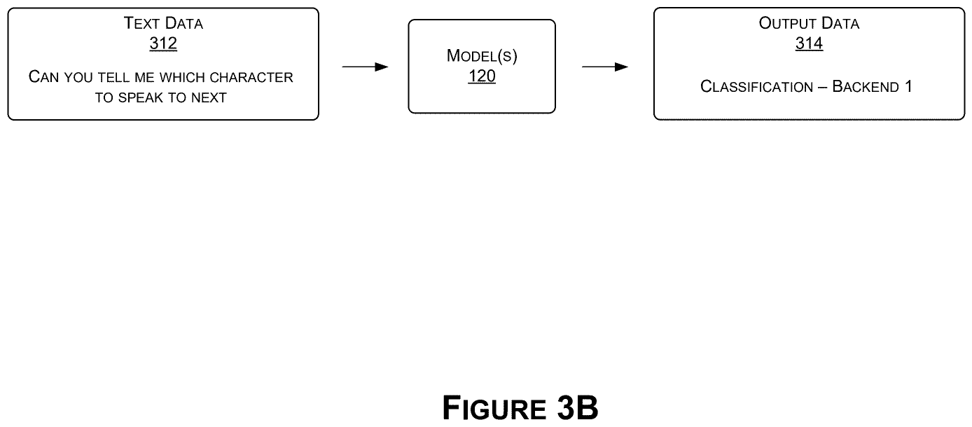

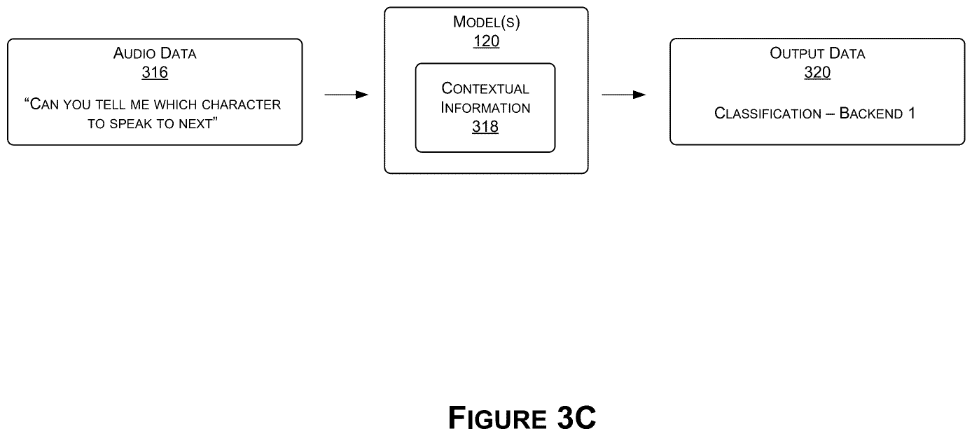

Referring back to the example of FIG. 1, to route a query, in some examples, the frontend 102 may use a classification routing technique 118 to determine a backend 108 based at least on classifying the query. One implementation of the classification routing technique 118 may include using one or more models 120—such as one or more language models and/or any other type of model—to process the text and output data that classifies a query with respect to a backend 108. In some examples, the model(s) 120 may be fine-tuned to classify queries. For instance, FIG. 3A illustrates an example of a process 300 for training one or more models to classify queries for routing to backends, in accordance with some embodiments of the present disclosure.

As shown, the model(s) 120 may be trained using training input data 302. In some examples, the training input data 302 may represent instances of text, where an instance of text corresponds to a query to perform one more processing tasks using a specific backend 108. For example, an instance of text may include “Can you tell me where to find the character” for a backend 108 that is associated with a game assistant, “Will you call my friend” for a backend 108 that is associated with a communications assistant, “Please update the brightness of the picture” for a backend 108 that is associated with controlling system settings, and/or any other instance of text representing any other type of query.

In some examples, the training input data 302 may further represent speech corresponding to the instances of text such that the model(s) 120 is able to determine contextual information associated with the instances of text which the model(s) then uses to classify queries. As described herein, contextual information may include, but is not limited to, voice characteristics (e.g., a tone, a pitch, resonance, timbre, etc.), sentiments, moods (e.g., happy, sad, mad, joyful, scared, etc.), environmental conditions, and/or any other contextual information associated with the instances of text and/or the speech corresponding to the instances in text. In some examples, during the training, the model(s) 120 may be configured to determine at least a portion of the contextual information and then use the determined contextual information when classifying the instances of text.

For a first example, the model(s) 120 may be trained to determine that instances of speech associated with first voice tones are to be classified to a specific backend 108 while instances of speech associated with second voice tones are to be classified to another backend 108. For instance, if a specific backend 108 is associated with machinery, the model(s) 120 may route queries for speech that includes an angry voice and/or tone to another backend 108 such that the user is unable to control the machinery when angry. For a second example, the model(s) 120 may be trained to determine that instances of speech associated with first moods (e.g., happy) are to be classified to a specific backend 108 while instances of speech associated with second moods (e.g., sad) are to be classified to another backend 108. For instance, if a specific backend 108 is again associated with machinery, the model(s) 120 may route queries for speech that includes an angry emotion to another backend 108 such that the user is unable to control the machinery when again angry.

In some examples, the training input data 302 may be real produced (e.g., generated specifically for training the language model(s) 120), generated from actual requests by users, synthetically produced, and/or any combination thereof.

The model(s) 120 may be trained using the training input data 302 along with corresponding ground truth data 304. As shown, in some examples, the ground truth data 304 may include at least backend classifications 306 that identify the backends 108 corresponding to the instances of text. For instance, in some examples, for each instance of the training input data 302, there may be corresponding ground truth data 304 classifying the training input data 302. For example, in the example above where the instance of text represented by the training input data 302 includes “Can you tell me where to find the character,” the ground truth data 304 may indicate a backend classification 306 as the game assistant. In some examples, the ground truth data 304 may be real produced, synthetically produced, human labeled, machine labeled, and/or any combination thereof.

As shown, the process 300 may include the model(s) 120 processing the training input data 302 to generate output data 308 corresponding to the training input data 302. For instance, the output data 308 may classify the instances of text corresponding to the queries as being associated with different backends 108. The process 300 may then include one or more training engines 310 using one or more loss functions that measure loss (e.g., error) in the output data 308 as compared to the ground truth data 304. For instance, in some examples, the loss function(s) may measure the loss based at least on differences between the classifications represented by the output data 308 and the backend classifications 306. The training engine(s) 310 may then perform backward pass computations to recursively compute gradients of the loss function(s) with respect to training parameters in order to update the parameters and/or weights of the model(s) 120, which is indicated by the arrow from the training engine(s) 310 to the model(s) 120.

Next, FIGS. 3B-3C illustrate examples of using the model(s) 120 to classify queries for routing to the backends 108, in accordance with some embodiments of the present disclosure. As shown by the example of FIG. 3B, either without training and/or after training the model(s) 120, text data 312 representing a query may be input into the model(s) 120. The model(s) 120 may then process the text data 312 and output data 314 representing a classification associated with the query. For instance, in the example of FIG. 3B, the output data 314 may classify the query as being associated with the first backend 108(1), such as when the first backend 108(1) is associated with a game assistant. The frontend 102 may then use the output data 314 to determine to route the query to the first backend 108(1).

Next, as shown by the example of FIG. 3C, rather than receiving the text data 312, the model(s) 120 may receive audio data 316 representing speech corresponding to the query and then classify the audio data 316. For instance, and as shown, the model(s) 120 may process the audio data 316 in order to determine contextual information 318 associated with the audio data 316 and/or the query. As described herein, the contextual information 318 may include the voice characteristics, the sentiments, the moods, the environmental conditions, and/or the like associated with the audio data 316 and/or the query. The model(s) 120 may then classify the query using the contextual information 318 and generate output data 320 representing the classification. As such, by performing the processes described with respect to the examples of FIGS. 3A-3C, the model(s) 120 may be trained to classify instances of text and/or speech corresponding to instances of text as being routed to the different backends 108.

Referring back to the example of FIG. 1, another implementation of the classification routing technique 118 may include using a retrieval system—such as a RAG system (and/or any other type of retrieval system)—to classify the query. For instance, the frontend 102 may include one or more databases 122 storing queries associated with the backends 108. In some examples, the frontend 102 may include an individual database 122 for each backend 108, where a database 122 then stores queries that may be processed by a backend 108. In some examples, the frontend 102 may include a single database 122 that stores queries that may be processed for multiple backends 108. In any of the examples, a database 122 may store at least the queries, classification information that relates the queries to the backend(s) 108, and/or vectors (e.g., embeddings) associated with the queries.

To classify an input query using the database(s) 122, the frontend 102 may initially process the text using one or more embedding components 124—such as a text embedder, an algorithm, a model, and/or the like—to generate a vector (e.g., an embedding) associated with the query. The frontend 102 may then use at least a query comparer 126 compare the generated vector to the vectors stored in the database(s) 122—such as by taking the inner products between the vectors, the dot products between the vectors, the Euclidean distances between the vectors, the cosine similarities between the vectors, and/or the like—to determine scores representing similarities between the generated query and the stored queries in the database(s) 122. Additionally, the frontend 102 may use a backend selector 128 to process the scores and classify the query as being associated with one of the backends 108.

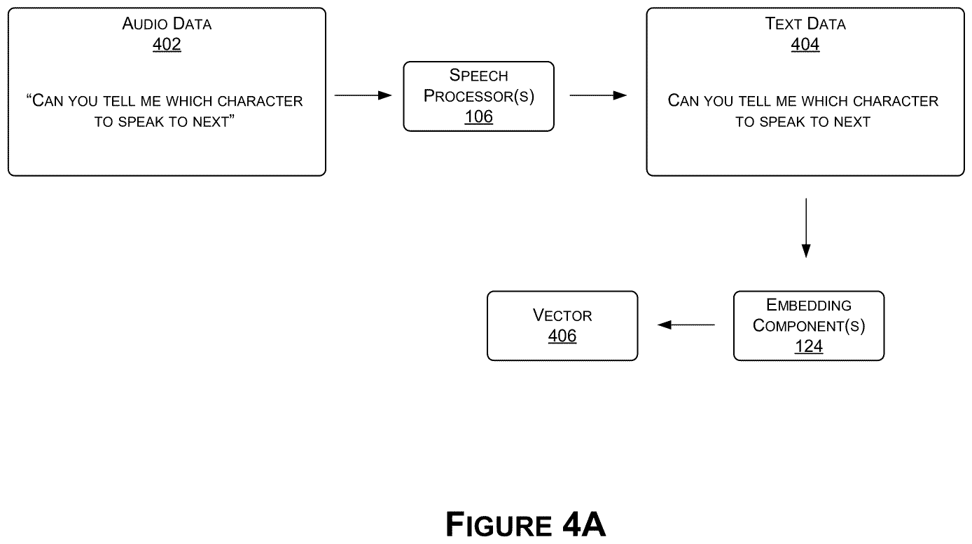

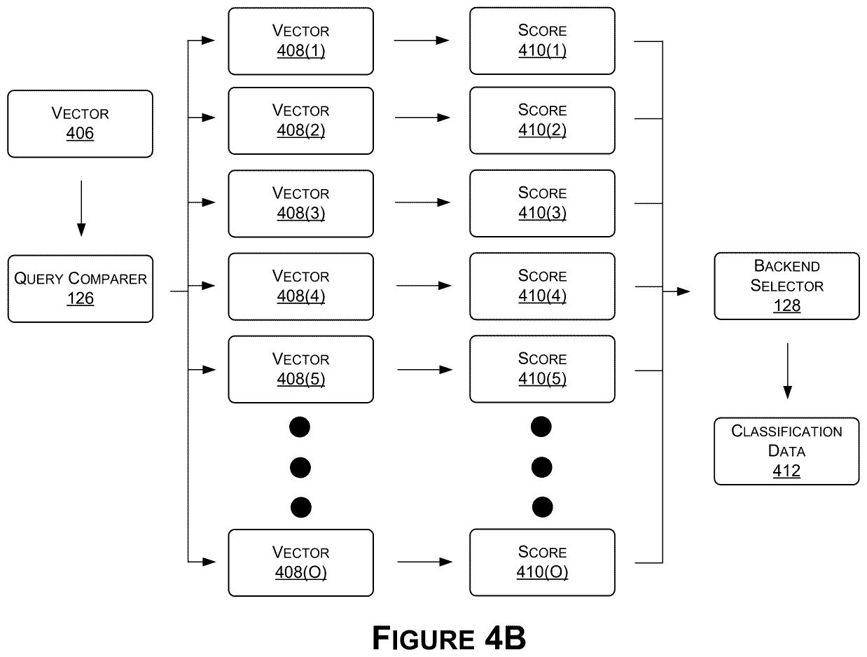

For more details, FIGS. 4A-4B illustrate an example of using the classification routing technique 118 to determine backends 108 for routing queries, in accordance with some embodiments of the present disclosure. As shown by the example of FIG. 4A, the speech processor(s) 106 may process audio data 402 representing user speech to generate text data 404 representing text corresponding to the user speech. In this example, the speech may correspond to a query about a gaming application such that the query is directed to a backend 108 associated with a game assistant. The embedding component(s) 124 may then process the text data 404 to generate a vector 406 that represents the query.

Next, and as shown by the example of FIG. 4B, the query comparer 126 may compare the vector 406 associated with the input query to vectors 408(1)-(O) (also referred to singularly as “vector 408” or in plural as “vectors 408”) associated with the stored queries in the database(s) 122. As described herein, in some examples, the frontend 102 may store all of the queries and/or the vectors 408 in a single database 122, where the queries and/or the vectors 408 may then be associated with classification data that classifies the queries and/or the vectors 408 with backends 108. However, in some examples, the queries and/or the vectors 408 may be stored in separate database 122 associated with the different backends 108. For example, a first portion of the queries and/or the vectors 408 may be stored in a first database 122 associated with the first backend 108(1), a second portion of the queries and/or the vectors 408 may be stored in a second database 122 associated with the second backend 108(2), and/or so forth.

Based at least on the comparison, the query comparer 126 may determine scores 410(1)-(O) (also referred to singularly as “score 410” or in plural as “scores 410”) indicating similarities between the input query and the stored queries. For instance, in some examples, the scores 410 may represent distances between the vector 408 and the vectors 410 in an embedding space. The backend selector 128 may then use the scores 410 to classify the input query as being associated with at least one of the backends 108.

For instance, in some examples, the backend selector 128 may identify the stored query in the database(s) 122 that is associated with the highest score 410. The backend selector 128 may then classify the input query as being associated with the same backend 108 as the stored query. Additionally, or alternatively, in some examples, the backend selector 128 may use the scores 410 to determine final scores associated with the backends 108. As described herein, a final score associated with a backend 108 may include an average score, a mode score, a median score, and/or any other type of score. For instance, the backend selector 128 may use the scores 410 associated with the first backend 108(1) to determine a first final score, the scores 410 associated with the second backend 108(2) to determine a second final score, the scores 410 associated with the third backend 108(3) to determine a third final score, and/or so forth. The backend selector 128 may then use the final scores to classify the input query, such as by classifying the input query with the backend 108 that is associated with the highest final score.

Additionally, or alternatively, in some examples, the backend selector 128 may weigh the scores 410 to determine final scores associated with the backends 108. For example, and for a backend 108, the backend selector 128 may identify a top number of the highest scores 410 (e.g., the two highest scores, the five highest scores, the ten highest scores, etc.) associated with the backend 108 and then use the identified scores 410 to determine the final score for the backend 108. Similar to the example above, the final score may include an average score, a mode score, a median score, and/or any other type of score that is determined using the identified scores 410. The backend selector 128 may then again use the final scores to classify the input query, such as by classifying the input query with the backend 108 that is associated with the highest final score. While these are just three example techniques for how the backend selector 128 may use the scores 410 to classify the input query with a backend 108, in other examples, the backend selector 128 may use additional and/or alternative techniques.

As shown, the backend selector 128 may output classification data 412 that classifies the input query with a backend 108. For example, if the first backend 108(1) is associated with a game assistant, then the classification data 412 may classify the input query as being associated with the first backend 108(1).

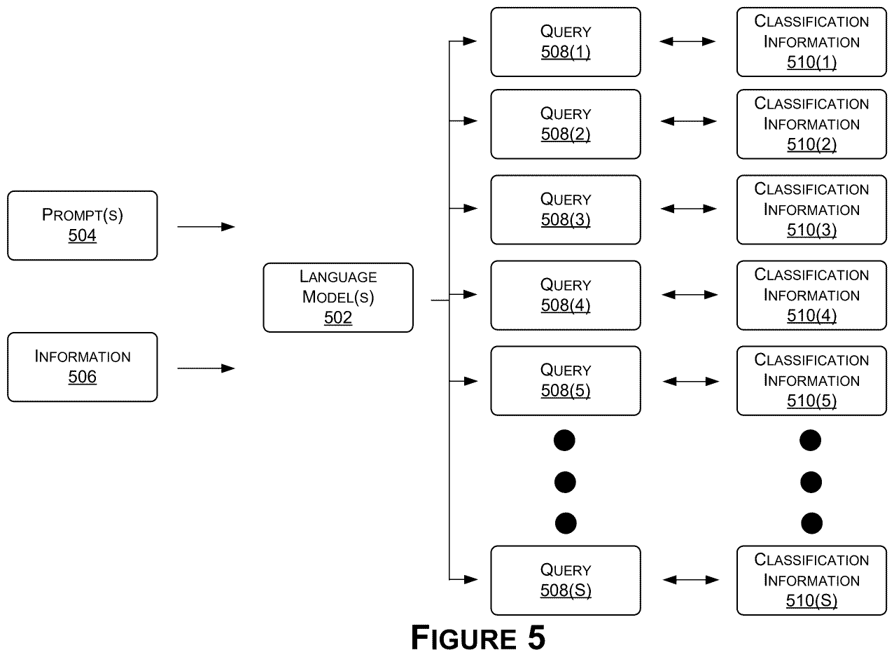

As described herein, one or more techniques may be used to generate the queries associated with the database(s) 122. For instance, FIG. 5 illustrates an example of using one or more language models 502 to generate queries associated with the backends 108, in accordance with some embodiments of the present disclosure. As shown, the inputs into the language model(s) 502 may include one or more prompts 504 and information 506. The prompt(s) 504 may be associated with requesting the language model(s) 502 to generate queries 508(1)-(S) (also referred to singularly as “query 508” or in plural as “queries 508”) for a backend 108 using the information 506. For instance, the prompt(s) 504 may cause the language model(s) 502 to generate the queries 508 that represent requests for information, requests to perform actions, requests for receiving content, requests to output content, and/or any other type of query.

The information 506 may include documents, webpages, manuals, text, stories, images, video, content, and/or any other type of information associated with the services and/or other tasks that are provided by the backend 108. In some examples, an entirety of the information 506 is input into the language model(s) 502 along with the prompt(s) 504. In such examples, the language model(s) 502 may process all of the information 506 to generate the queries 508. However, in some examples, portions of the information 506 may be separately input into the language model(s) 502 along with the prompt(s) 504. In such examples, the language model(s) 502 may separately process the portions of the information 506 to generate one or more queries 508 associated with individual portions.

As further shown in the example of FIG. 5, the queries 508 may be associated with classification information 510(1)-(S) (also referred to as “classification information 510”) that indicates at least the backend 108 for which the queries 508 are associated. For example, if the information 506 is associated with the first backend 108(1), then the classification information 510 may indicate that the queries 508 are also associated with the first backend 108(1).

Referring back to the example of FIG. 1, in some examples, the frontend 102 may use a serialized routing technique 130 to determine a backend 108 based at least on an order, where the order is represented by order data 132. For instance, the order may indicate a first backend 108, followed by a second backend 108, followed by a third backend 108, and/or so forth. In some examples, the order may include a static order which may not change over a period of time. However, in some examples, the order may include a dynamic order that changes over a period of time. For example, the frontend 102 may update the order based on one or more factors, such as how often the backends 108 are used to process queries, programs and/or applications being executed, which backend 108 operating system is in the foreground and which backend 108 operating system is in the background, user preferences, user history, information from an operating system scheduler (which may indicate one or more of these factors, such as which is operating in the foreground and which is operating in the background), and/or any other factors. In other words, the frontend 102 may update the order such that the most likely backend 108 for processing queries is first, followed by the second most likely backend 108, followed by the third most likely backend 108, and/or so forth.

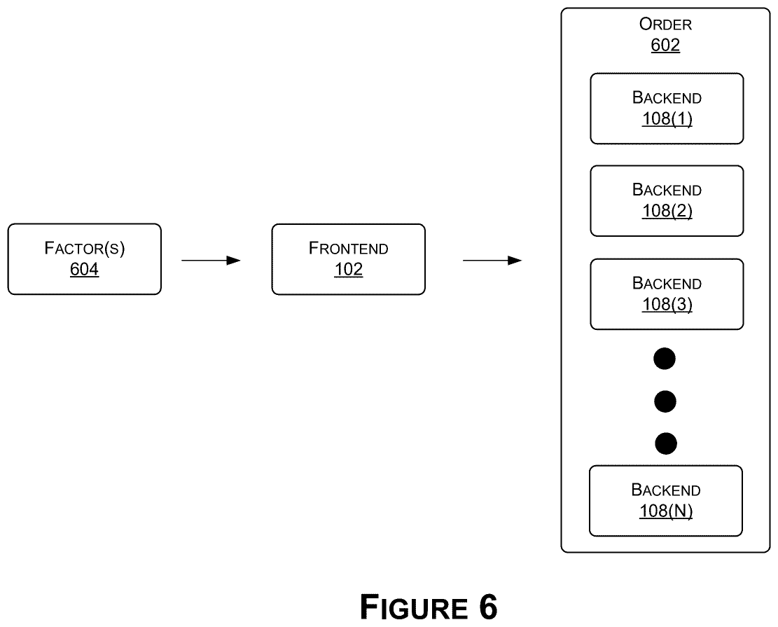

For instance, FIG. 6 illustrates an example of using the serialized routing technique 130 to determine the backends 108 for routing queries, in accordance with some embodiments of the present disclosure. As shown, the serialized routing technique 130 may be associated with an order 602 (which may be represented by the order data 132) that includes the first backend 108(1), followed by the second backend 108(2), followed by the third backend 108(3), and so forth until reaching the last backend 108(N). In some examples, the order 602 may be static such that the frontend 102 uses the same order 602 when routing queries over a period of time. However, in some examples, the order 602 may be dynamic such that the frontend 102 updates the order 602 based at least on one or more factors 604. As described herein, the factor(s) 604 may include, but is not limited to, how often the backends 108 are used to process queries, programs and/or applications being executed, user preferences, user history, and/or any other factors.

For a first example, the frontend 102 may determine that the first backend 108(1) is used the most to process queries, followed by the second backend 108(2), the third backend 108(3), and so forth until the last backend 108(N). As such, the frontend 102 may use that information to generate the order 602. For a second example, the frontend 102 may determine that a program and/or application currently being executed is associated with the first backend 108(1). For instance, if the first backend 108(1) includes a game assistant, the frontend 102 may determine that a gaming application associated with the game assistant is being executed. As such, the frontend 102 may generate the order 602 to start with at least the first backend 108(1). Still, for a third example, if the operating system of the first backend 108(1) is operating in the frontend while the operating system of the second backend 108(2) is operating in the background, then the frontend 102 may determine that at least the first backend 108(1) is before the second backend 108(2) in the order 602.

Referring back to the example of FIG. 1, after determining a backend 108 using one or more of the routing techniques described herein, the frontend 102 may then route at least a portion of the input data 104 (and/or the text data representing the text corresponding to the query) to the backend 108. In some examples, the backend 108 may then process the input data 104 to perform a task. For example, the backend 108 may generate output data associated with the query (e.g., a response to the query), provide content associated with the query, update one or more systems parameters, and/or perform any other type of action. Additionally, in some examples, the frontend 102 may provide one or more outputs to a user that provided the query. For a first example, if the query includes a request for information, then the frontend 102 may receive output data 134 representing a response to the query from the backend 108 and provide the response to the user. For a second example, if the query includes a request for content, such as images, then the frontend 102 may receive output data 134 representing the content from the backend 108 and provide the content to the user.

However, in some examples, the backend 108 may be unable to process and/or respond to the query. For example, the frontend 102 may determine the wrong backend 108 associated with the query. In such examples, the frontend 102 may receive an indication from the backend 108 that the backend 108 is unable to process the query (e.g., the backend 108 has rejected the query). In response, the frontend 102 may determine another backend 108 to route the query, such as by using one or more of the routing techniques described herein. For a first example, the frontend 102 may use the classification routing technique 118 to again classify the query using another backend 108. For a second example, the frontend 102 may use the serialized routing technique 130 to determine the second backend 108 that is after the initial backend 108 in the order. In either of the examples, the frontend 102 may then route at least a portion of the input data 104 to the other backend 108. In some examples, these processes may then continue to repeat until the frontend 102 identifies a backend 108 that is capable of processing the input data 104.

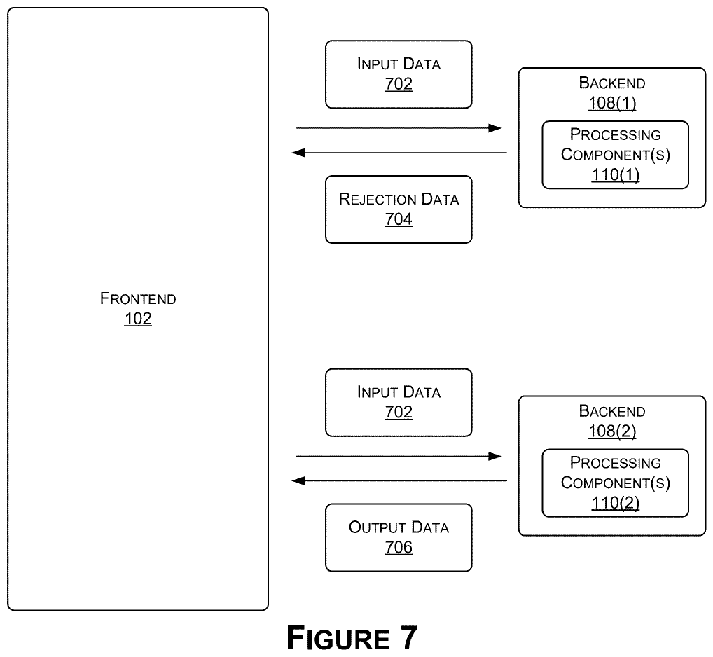

For instance, FIG. 7 illustrates an example of routing a query to different backends 108 for processing, in accordance with some embodiments of the present disclosure. As shown, the frontend 102 may perform one or more of the routing techniques described herein to initially determine to route a query to the first backend 108(1). As such, the frontend 102 may send input data 702 representing the query to the first backend 108(1). However, in the example of FIG. 7, the first backend 108(1) may reject the query, such as based on the first backend 108(1) being unable to process the query. As such, the frontend 102 may receive rejection data 704 from the first backend 108(1), where the rejection data 704 indicates that the query was rejected.

The frontend 102 may then perform one or more of the routing techniques described herein to determine to route the query to the second backend 108(2). As such, the frontend 102 may send the input data 702 representing the query to the second backend 108(2). In the example of FIG. 7, the second backend 108(2) may be capable of processing the query. As such, the frontend 102 may receive output data 706 from the second backend 108(2), where the output data 706 represents an acceptance of the query and/or a response to the query.

Referring back to the example of FIG. 1, in some examples, the frontend 102 may use multiple routing techniques to route queries to the backends 108. For example, and for a query, the frontend 102 may use the keyword routing technique 112 to determine a first backend 108, the classification routing technique 118 to determine a second backend 108, and/or the serialized routing technique 130 to determine a third backend 108. The frontend 102 may then use the results to determine a final backend 108 for routing the query. For instance, in some examples, if each of the results indicates the same backend 108, then the frontend 102 may route the query to the backend 108. In some examples, if a majority of the results indicate the same backend 108, then the frontend 102 may route the query to the backend 108. Still, in some examples, if the results indicate different backends 108, then the frontend 102 may choose the result that is associated with the highest priority routing technique. For instance, the frontend 102 may determine that the classification routing technique 118 includes the highest priority and, as such, route the query to the backend 108 that is determined using the classification routing technique 118.

While the examples of FIG. 1 describe determining a single backend 108 for routing a query, in other examples, the frontend 102 may perform similar processes to determine multiple backends 108 for routing a query. For a first example, the frontend 102 may use the classification routing technique 118 to classify a query using two different backends 108. For a second example, the frontend 102 may use the serialized routing technique 130 to determine the first two backends 108 included in the order. Still, for a third example, the frontend 102 may use a first routing technique to determine a first backend 108 and a second routing technique to determine a second backend 108. In any of the examples, the frontend 102 may send the input data 104 representing the query to both of the backends 108 for processing even though only one of the backends 108 may perform a task using the query (e.g., the other backend 108 may reject the query).

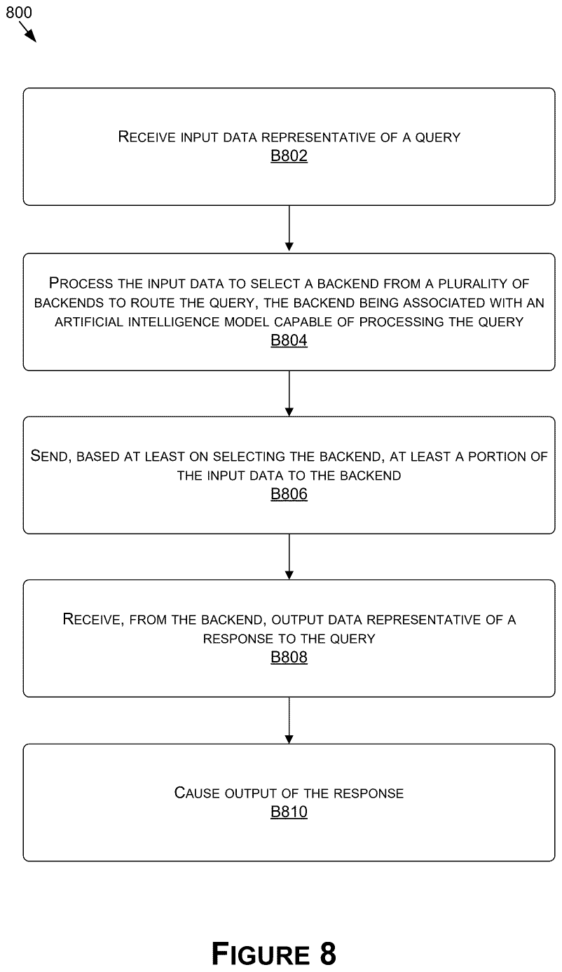

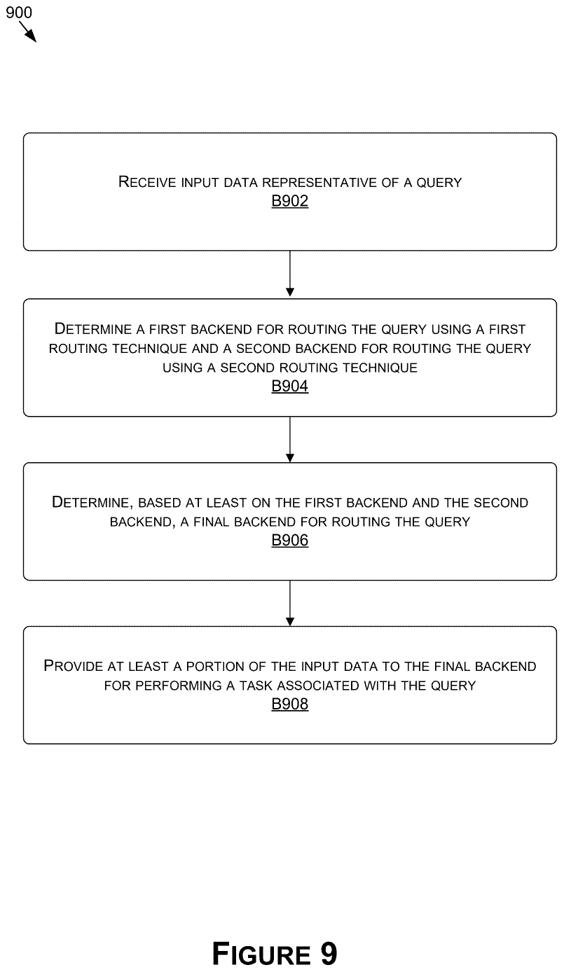

Now referring to FIGS. 8 and 9, each block of methods 800 and 900, described herein, comprises a computing process that may be performed using any combination of hardware, firmware, and/or software. For instance, various functions may be carried out by a processor executing instructions stored in memory. The methods 800 and 900 may also be embodied as computer-usable instructions stored on computer storage media. The methods 800 and 900 may be provided by a standalone application, a service or hosted service (standalone or in combination with another hosted service), or a plug-in to another product, to name a few. In addition, these methods 800 and 900 described, by way of example, with respect to FIG. 1. However, these methods 800 and 900 may additionally or alternatively be executed by any one system, or any combination of systems, including, but not limited to, those described herein.

FIG. 8 illustrates a flow diagram showing a method 800 for routing a query in a multi-backend artificial intelligence system, in accordance with some embodiments of the present disclosure. The method 800, at block B802, may include receiving input data representative of a query. For instance, the frontend 102 may receive the input data 104 representing the query. As described herein, the input data 104 may include, but is not limited to, audio data representing speech corresponding to the query, text data representing text describing the query, selection data representing one or more selections associated with the query, image data representing one or more images of a user gesturing the query, and/or any other type of input data. Additionally, in some examples, the frontend 102 may then use the speech processor(s) 106 to process at least a portion of the input data 104 to generate text data representing text corresponding to the query.

The method 800, at block B804, may include processing the input data to select a backend from a plurality of backends, the backend being associated with an artificial intelligence model capable of processing the query. For instance, the frontend 102 may use the keyword routing technique 112, the classification routing technique 118, and/or the serialized routing technique 130 to determine the backend 108 for routing the query. For a first example, and using the keyword routing technique 112, the frontend 102 may determine an identifier represented by the query and use the identifier to determine the backend 108. For a second example, and using the classification routing technique 118, the frontend 102 may process the query in order to classify the query as being associated with the backend 108.

The method 800, at block B806, may include sending, based at least on selecting the backend, at least a portion of the input data to the backend. For instance, the frontend 102 may send at least a portion of the input data 104 to the backend 108 for processing. For example, the backend 108 may use the processing component(s) 110 to process the input data 104 in order to perform a task. For instance, the backend 108 may generate output data associated with the query (e.g., a response to the query), provide content associated with the query, update one or more systems parameters, and/or perform any other type of action. In some examples, and as described herein, the backend 108 may initially accept the query for processing and/or notify the frontend 102 that the backend 108 is capable of processing the query.

The method 800, at block B808, may include receiving, from the backend, output data representative of a response to the query and the method 800, at block B810, may include causing output of the response. For instance, the frontend 102 may receive the output data 134 from the backend 108, where the output data 134 represents at least a response to the query. The frontend 102 may then cause the output of the response using the output data 134. For example, the frontend 102 may cause a displaying of content associated with the response, an outputting of audio associated with the response, and/or any other type of content to be output.

FIG. 9 illustrates a flow diagram showing a method 900 for using multiple routing techniques to route queries to backends, in accordance with some embodiments of the present disclosure. The method 900, at block B902, may include receiving input data representative of a query. For instance, the frontend 102 may receive the input data 104 representing the query. As described herein, the input data 104 may include, but is not limited to, audio data representing speech corresponding to the query, text data representing text describing the query, selection data representing one or more selections associated with the query, image data representing one or more images of a user gesturing the query, and/or any other type of input data. Additionally, in some examples, the frontend 102 may then use the speech processor(s) 106 to process at least a portion of the input data 104 to generate text data representing text corresponding to the query.

The method 900, at block B904, may include determining a first backend for routing the query using a first routing technique and a second backend for routing the query using a second routing technique. For instance, the frontend 102 may determine the first backend 108 for routing the query using the first routing technique (e.g., the keyword routing technique 112, the classification routing technique 118, or the serialized routing technique 130) and the second backend 108 for routing the query using the second routing technique (e.g., the keyword routing technique 112, the classification routing technique 118, or the serialized routing technique 130). In some examples, the first backend 108 may be the same as the second backend 108 while, in other examples, the first backend 108 may be different than the second backend 108.

The method 900, at block B906, may include determining, based at least on the first backend and the second backend, a final backend for routing the query. For instance, the frontend 102 may determine the final backend 108 using the first backend 108 and the second backend 108. As described herein, in some examples, if the first backend 108 is the same as the second backend 108, then the frontend 102 may select that backend 108 as the final backend 108. However, if the first backend 108 is different than the second backend 108, then the frontend 102 may use one or more factors to determine whether to use the first backend 108 or the second backend 108 as the final backend 108 for routing the query.

The method 900, at block B908, may include providing at least a portion of the input data to the final backend for performing a task associated with the query. For instance, the frontend 102 may send at least a portion of the input data 104 to the final backend 108 for processing to perform the task associated with the query.

### Example Language Models

In at least some embodiments, language models, such as large language models (LLMs), small language models (SLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/SLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/SLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/SLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/SLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/SLMs/VLMs/MMLMs/etc. may also include one or more diffusion block(s) (e.g., denoisers). The LLMs/SLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/SLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/SLMs/VLMs/MMLMs/etc.

In various embodiments, the LLMs/SLMs/VLMs/MMLMs/etc. may be trained using unsupervised learning, in which an LLMs/SLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/SLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/SLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/SLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/SLMs/VLMs/MMLMs/etc., and/or preventing the output or presentation (e.g., display, audio output, etc.) of information generating using the LLMs/SLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/SLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/SLMs/VLMs/MMLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/SLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

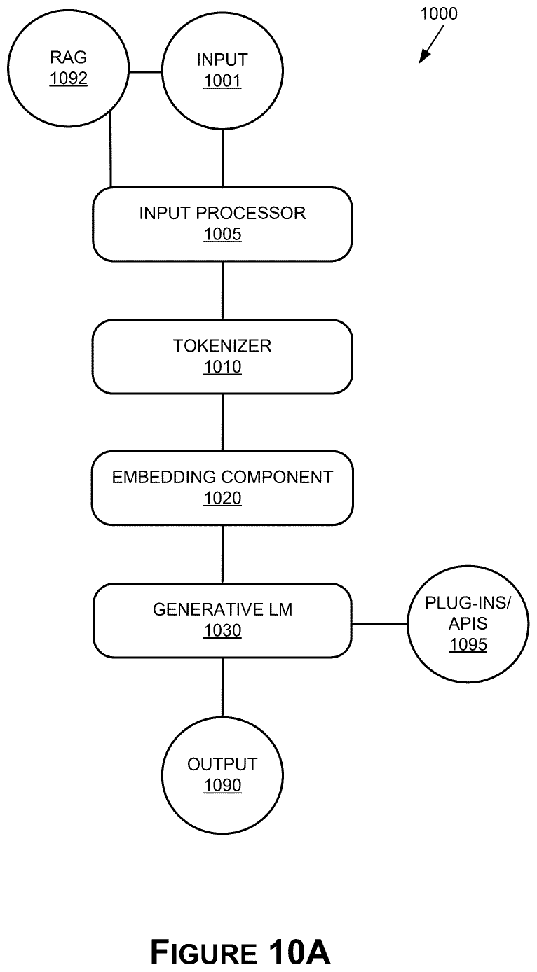

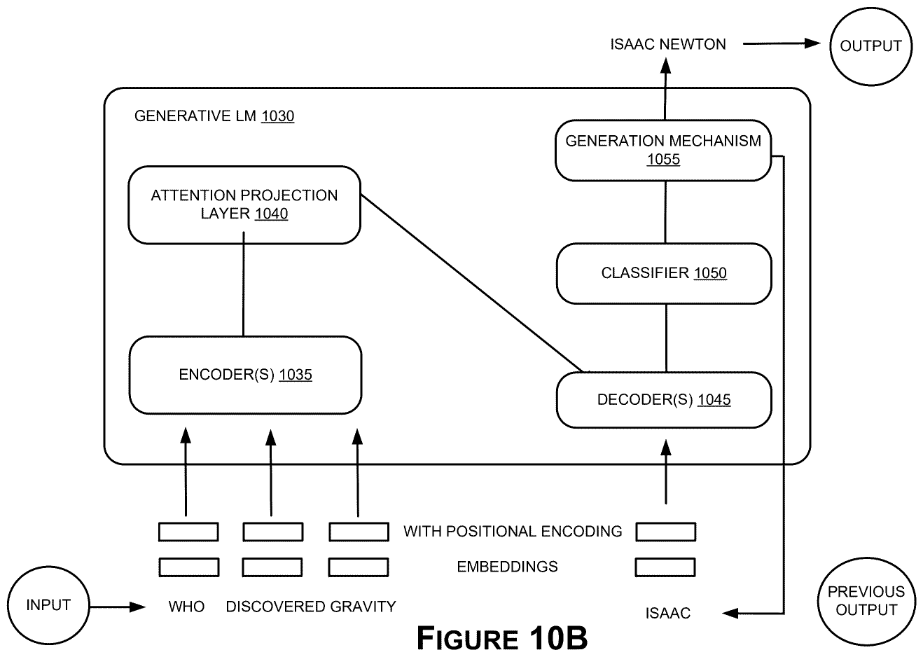

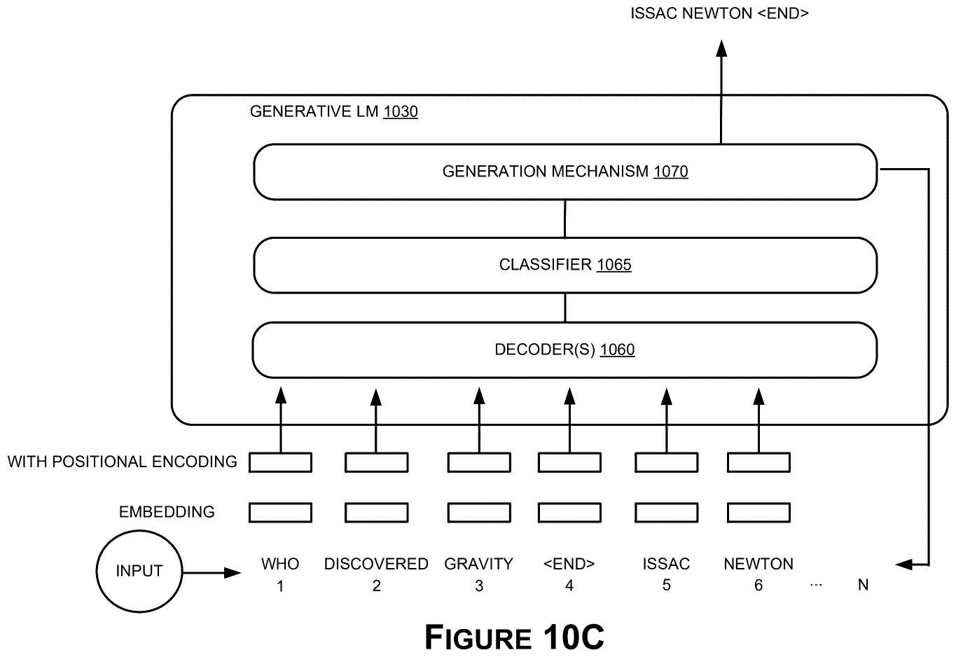

FIG. 10A is a block diagram of an example generative language model system 1000 suitable for use in implementing at least some embodiments of the present disclosure. In the example illustrated in FIG. 10A, the generative language model system 1000 includes a retrieval augmented generation (RAG) component 1092, an input processor 1005, a tokenizer 1010, an embedding component 1020, plug-ins/APIs 1095, and a generative language model (LM) 1030 (which may include an LLM, a SLM, a VLM, a multi-modal LM, etc.).

At a high level, the input processor 1005 may receive an input 1001 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 1030 (e.g., LLM/SLM/VLM/MMLM/etc.). In some embodiments, the input 1001 includes plain text in the form of one or more sentences, paragraphs, and/or documents. Additionally or alternatively, the input 1001 may include numerical sequences, precomputed embeddings (e.g., word or sentence embeddings), and/or structured data (e.g., in tabular formats, JSON, or XML). In some implementations in which the generative LM 1030 is capable of processing multi-modal inputs, the input 1001 may combine text (or may omit text) with image data, audio data, video data, design data, USD data, and/or other types of input data, such as but not limited to those described herein. Taking raw input text as an example, the input processor 1005 may prepare raw input text in various ways. For example, the input processor 1005 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 1005 may remove stopwords to reduce noise and focus the generative LM 1030 on more meaningful content. The input processor 1005 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 1092 (which may include one or more RAG models, and/or may be performed using the generative LM 1030 itself) may be used to retrieve additional information to be used as part of the input 1001 or prompt. RAG may be used to enhance the input to the LLM/SLM/VLM/MMLM/etc. with external knowledge, so that answers to specific questions or queries or requests are more relevant—such as in a case where specific knowledge is required. The RAG component 1092 may fetch this additional information (e.g., grounding information, such as grounding text/image/video/audio/USD/CAD/etc.) from one or more external sources, which can then be fed to the LLM/SLM/VLM/MMLM/etc. along with the prompt to improve accuracy of the responses or outputs of the model.

For example, in some embodiments, the input 1001 may be generated using the query or input to the model (e.g., a question, a request, etc.) in addition to data retrieved using the RAG component 1092. In some embodiments, the input processor 1005 may analyze the input 1001 and communicate with the RAG component 1092 (or the RAG component 1092 may be part of the input processor 1005, in embodiments) in order to identify relevant text and/or other data to provide to the generative LM 1030 as additional context or sources of information from which to identify the response, answer, or output 1090, generally. For example, where the input indicates that the user is interested in a desired tire pressure for a particular make and model of vehicle, the RAG component 1092 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 1092 may retrieve a prior stored conversation history—or at least a summary thereof—and include the prior conversation history along with the current ask/request as part of the input 1001 to the generative LM 1030.

The RAG component 1092 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 1092 and the embeddings of the chunks along with the embeddings of the query may be compared to identify the most similar/related embeddings to the query, which may be supplied to the generative LM 1030 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/SLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/SLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/SLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/SLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 1092 may implement a plugin, API, user interface, and/or other functionality to perform RAG. For example, a graph RAG plug-in may be used by the LLM/SLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 1010 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 1030 to understand morphological variations and handle out-of-vocabulary words more effectively. Character-based tokenization represents each character as a separate token, enabling the generative LM 1030 to process text at a fine-grained level. The choice of tokenization strategy may depend on factors such as the language being processed, the task at hand, and/or characteristics of the training dataset. As such, the tokenizer 1010 may convert the (e.g., processed) text into a structured format according to tokenization schema being implemented in the particular embodiment.

The embedding component 1020 may use any known embedding technique to transform discrete tokens into (e.g., dense, continuous vector) representations of semantic meaning. For example, the embedding component 1020 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 1001 includes image data/video data/etc., the input processor 1001 may resize the data to a standard size compatible with format of a corresponding input channel and/or may normalize pixel values to a common range (e.g., 0 to 1) to ensure a consistent representation, and the embedding component 1020 may encode the image data using any known technique (e.g., using one or more convolutional neural networks (CNNs) to extract visual features). In some implementations in which the input 1001 includes audio data, the input processor 1001 may resample an audio file to a consistent sampling rate for uniform processing, and the embedding component 1020 may use any known technique to extract and encode audio features—such as in the form of a spectrogram (e.g., a mel-spectrogram). In some implementations in which the input 1001 includes video data, the input processor 1001 may extract frames or apply resizing to extracted frames, and the embedding component 1020 may extract features such as optical flow embeddings or video embeddings and/or may encode temporal information or sequences of frames. In some implementations in which the input 1001 includes multi-modal data, the embedding component 1020 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 1030 and/or other components of the generative LM system 1000 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 1020 may apply an encoded representation of the input 1001 to the generative LM 1030, and the generative LM 1030 may process the encoded representation of the input 1001 to generate an output 1090, which may include responsive text and/or other types of data.

As described herein, in some embodiments, the generative LM 1030 may be configured to access or use—or capable of accessing or using—plug-ins/APIs 1095 (which may include one or more plug-ins, application programming interfaces (APIs), databases, data stores, repositories, etc.). For example, for certain tasks or operations that the generative LM 1030 is not ideally suited for, the model may have instructions (e.g., as a result of training, and/or based on instructions in a given prompt, such as those retrieved using the RAG component 1092) to access one or more plug-ins/APIs 1095 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 1095 to the plug-in/API 1095, the plug-in/API 1095 may process the information and return an answer to the generative LM 1030, and the generative LM 1030 may use the response to generate the output 1090. This process may be repeated—e.g., recursively—for any number of iterations and using any number of plug-ins/APIs 1095 until an output 1090 that addresses each ask/question/request/process/operation/etc. from the input 1001 can be generated. As such, the model(s) may not only rely on its own knowledge from training on a large dataset(s) and/or from data retrieved using the RAG component 1092, but also on the expertise or optimized nature of one or more external resources—such as the plug-ins/APIs 1095.

FIG. 10B is a block diagram of an example implementation in which the generative LM 1030 includes a transformer encoder-decoder. For example, assume input text such as “Who discovered gravity” is tokenized (e.g., by the tokenizer 1010 of FIG. 10A) into tokens such as words, and each token is encoded (e.g., by the embedding component 1020 of FIG. 910A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 1035 of the generative LM 1030.

In an example implementation, the encoder(s) 1035 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 1040 may convert the context vector into attention vectors (keys and values) for the decoder(s) 1045.

In an example implementation, the decoder(s) 1045 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 1035, in an example transformer architecture, each token (e.g., word) flows through a separate path in the decoder(s) 1045. During a first pass, the decoder(s) 1045, a classifier 1050, and a generation mechanism 1055 may generate a first token, and the generation mechanism 1055 may apply the generated token as an input during a second pass. The process may repeat in a loop, successively generating and adding tokens (e.g., words) to the output from the preceding pass and applying the token embeddings of the composite sequence with positional encodings as an input to the decoder(s) 1045 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 1035, except that it creates its queries from the layer below it and takes the keys and values (e.g., matrix) from the output of the encoder(s) 1035.

As such, the decoder(s) 1045 may output some decoded (e.g., vector) representation of the input being applied during a particular pass. The classifier 1050 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 1055 may select or sample a word or token based on a corresponding predicted probability (e.g., select the word with the highest predicted probability) and append it to the output from a previous pass, generating each word or token sequentially. The generation mechanism 1055 may repeat the process, triggering successive decoder inputs and corresponding predictions until selecting or sampling a symbol or token that represents the end of the response, at which point, the generation mechanism 1055 may output the generated response.

FIG. 10C is a block diagram of an example implementation in which the generative LM 1030 includes a decoder-only transformer architecture. For example, the decoder(s) 1060 of FIG. 10C may operate similarly as the decoder(s) 1045 of FIG. 10B except each of the decoder(s) 1060 of FIG. 10C omits the encoder-decoder self-attention layer (since there is no encoder in this implementation). As such, the decoder(s) 1060 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 1060. As with the decoder(s) 1045 of FIG. 10B, each token (e.g., word) may flow through a separate path in the decoder(s) 1060, and the decoder(s) 1060, a classifier 1065, and a generation mechanism 1070 may use auto-regression to sequentially generate one token at a time until predicting a symbol or token that represents the end of the response. The classifier 1065 and the generation mechanism 1070 may operate similarly as the classifier 1050 and the generation mechanism 1055 of FIG. 10B, with the generation mechanism 1070 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

FIG. 11 is a block diagram of an example computing device(s) 1100 suitable for use in implementing some embodiments of the present disclosure. Computing device 1100 may include an interconnect system 1102 that directly or indirectly couples the following devices: memory 1104, one or more central processing units (CPUs) 1106, one or more graphics processing units (GPUs) 1108, a communication interface 1110, input/output (I/O) ports 1112, input/output components 1114, a power supply 1116, one or more presentation components 1118 (e.g., display(s)), and one or more logic units 1120. In at least one embodiment, the computing device(s) 1100 may comprise one or more virtual machines (VMs), and/or any of the components thereof may comprise virtual components (e.g., virtual hardware components). For non-limiting examples, one or more of the GPUs 1108 may comprise one or more vGPUs, one or more of the CPUs 1106 may comprise one or more vCPUs, and/or one or more of the logic units 1120 may comprise one or more virtual logic units. As such, a computing device(s) 1100 may include discrete components (e.g., a full GPU dedicated to the computing device 1100), virtual components (e.g., a portion of a GPU dedicated to the computing device 1100), or a combination thereof.

Although the various blocks of FIG. 11 are shown as connected via the interconnect system 1102 with lines, this is not intended to be limiting and is for clarity only. For example, in some embodiments, a presentation component 1118, such as a display device, may be considered an I/O component 1114 (e.g., if the display is a touch screen). As another example, the CPUs 1106 and/or GPUs 1108 may include memory (e.g., the memory 1104 may be representative of a storage device in addition to the memory of the GPUs 1108, the CPUs 1106, and/or other components). In other words, the computing device of FIG. 11 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 11.

The interconnect system 1102 may represent one or more links or busses, such as an address bus, a data bus, a control bus, or a combination thereof. The interconnect system 1102 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1106 may be directly connected to the memory 1104. Further, the CPU 1106 may be directly connected to the GPU 1108. Where there is direct, or point-to-point connection between components, the interconnect system 1102 may include a PCIe link to carry out the connection. In these examples, a PCI bus need not be included in the computing device 1100.

The memory 1104 may include any of a variety of computer-readable media. The computer-readable media may be any available media that may be accessed by the computing device 1100. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1104 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1100. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1106 may be configured to execute at least some of the computer-readable instructions to control one or more components of the computing device 1100 to perform one or more of the methods and/or processes described herein. The CPU(s) 1106 may each include one or more cores (e.g., one, two, four, eight, twenty-eight, seventy-two, etc.) that are capable of handling a multitude of software threads simultaneously. The CPU(s) 1106 may include any type of processor, and may include different types of processors depending on the type of computing device 1100 implemented (e.g., processors with fewer cores for mobile devices and processors with more cores for servers). For example, depending on the type of computing device 1100, the processor may be an Advanced RISC Machines (ARM) processor implemented using Reduced Instruction Set Computing (RISC) or an x86 processor implemented using Complex Instruction Set Computing (CISC). The computing device 1100 may include one or more CPUs 1106 in addition to one or more microprocessors or supplementary co-processors, such as math co-processors.

In addition to or alternatively from the CPU(s) 1106, the GPU(s) 1108 may be configured to execute at least some of the computer-readable instructions to control one or more components of the computing device 1100 to perform one or more of the methods and/or processes described herein. One or more of the GPU(s) 1108 may be an integrated GPU (e.g., with one or more of the CPU(s) 1106 and/or one or more of the GPU(s) 1108 may be a discrete GPU. In embodiments, one or more of the GPU(s) 1108 may be a coprocessor of one or more of the CPU(s) 1106. The GPU(s) 1108 may be used by the computing device 1100 to render graphics (e.g., 3D graphics) or perform general purpose computations. For example, the GPU(s) 1108 may be used for General-Purpose computing on GPUs (GPGPU). The GPU(s) 1108 may include hundreds or thousands of cores that are capable of handling hundreds or thousands of software threads simultaneously. The GPU(s) 1108 may generate pixel data for output images in response to rendering commands (e.g., rendering commands from the CPU(s) 1106 received via a host interface). The GPU(s) 1108 may include graphics memory, such as display memory, for storing pixel data or any other suitable data, such as GPGPU data. The display memory may be included as part of the memory 1104. The GPU(s) 1108 may include two or more GPUs operating in parallel (e.g., via a link). The link may directly connect the GPUs (e.g., using NVLINK) or may connect the GPUs through a switch (e.g., using NVSwitch). When combined together, each GPU 1108 may generate pixel data or GPGPU data for different portions of an output or for different outputs (e.g., a first GPU for a first image and a second GPU for a simulated image). Each GPU may include its own memory, or may share memory with other GPUs.

In addition to or alternatively from the CPU(s) 1106 and/or the GPU(s) 1108, the logic unit(s) 1120 may be configured to execute at least some of the computer-readable instructions to control one or more components of the computing device 1100 to perform one or more of the methods and/or processes described herein. In embodiments, the CPU(s) 1106, the GPU(s) 1108, and/or the logic unit(s) 1120 may discretely or jointly perform any combination of the methods, processes and/or portions thereof. One or more of the logic units 1120 may be part of and/or integrated in one or more of the CPU(s) 1106 and/or the GPU(s) 1108 and/or one or more of the logic units 1120 may be discrete components or otherwise external to the CPU(s) 1106 and/or the GPU(s) 1108. In embodiments, one or more of the logic units 1120 may be a coprocessor of one or more of the CPU(s) 1106 and/or one or more of the GPU(s) 1108.

Examples of the logic unit(s) 1120 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1110 may include one or more receivers, transmitters, and/or transceivers that enable the computing device 1100 to communicate with other computing devices via an electronic communication network, included wired and/or wireless communications. The communication interface 1110 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1120 and/or communication interface 1110 may include one or more data processing units (DPUs) to transmit data received over a network and/or through interconnect system 1102 directly to (e.g., a memory of) one or more GPU(s) 1108.

The I/O ports 1112 may enable the computing device 1100 to be logically coupled to other devices including the I/O components 1114, the presentation component(s) 1118, and/or other components, some of which may be built in to (e.g., integrated in) the computing device 1100. Illustrative I/O components 1114 include a microphone, mouse, keyboard, joystick, game pad, game controller, satellite dish, scanner, printer, wireless device, etc. The I/O components 1114 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1100. The computing device 1100 may be include depth cameras, such as stereoscopic camera systems, infrared camera systems, RGB camera systems, touchscreen technology, and combinations of these, for gesture detection and recognition. Additionally, the computing device 1100 may include accelerometers or gyroscopes (e.g., as part of an inertia measurement unit (IMU)) that enable detection of motion. In some examples, the output of the accelerometers or gyroscopes may be used by the computing device 1100 to render immersive augmented reality or virtual reality.

The power supply 1116 may include a hard-wired power supply, a battery power supply, or a combination thereof. The power supply 1116 may provide power to the computing device 1100 to enable the components of the computing device 1100 to operate.

The presentation component(s) 1118 may include a display (e.g., a monitor, a touch screen, a television screen, a heads-up-display (HUD), other display types, or a combination thereof), speakers, and/or other presentation components. The presentation component(s) 1118 may receive data from other components (e.g., the GPU(s) 1108, the CPU(s) 1106, DPUs, etc.), and output the data (e.g., as an image, video, sound, etc.).

### Example Data Center

FIG. 12 illustrates an example data center 1200 that may be used in at least one embodiments of the present disclosure. The data center 1200 may include a data center infrastructure layer 1210, a framework layer 1220, a software layer 1230, and/or an application layer 1240.

As shown in FIG. 12, the data center infrastructure layer 1210 may include a resource orchestrator 1212, grouped computing resources 1214, and node computing resources (“node C.R.s”) 1216(1)-1216(N), where “N” represents any whole, positive integer. In at least one embodiment, node C.R.s 1216(1)-1216(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1216(1)-1216(N) may correspond to a server having one or more of the above-mentioned computing resources. In addition, in some embodiments, the node C.R.s 1216(1)-12161 (N) may include one or more virtual components, such as vGPUs, vCPUs, and/or the like, and/or one or more of the node C.R.s 1216(1)-1216(N) may correspond to a virtual machine (VM).

In at least one embodiment, grouped computing resources 1214 may include separate groupings of node C.R.s 1216 housed within one or more racks (not shown), or many racks housed in data centers at various geographical locations (also not shown). Separate groupings of node C.R.s 1216 within grouped computing resources 1214 may include grouped compute, network, memory or storage resources that may be configured or allocated to support one or more workloads. In at least one embodiment, several node C.R.s 1216 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1212 may configure or otherwise control one or more node C.R.s 1216(1)-1216(N) and/or grouped computing resources 1214. In at least one embodiment, resource orchestrator 1212 may include a software design infrastructure (SDI) management entity for the data center 1200. The resource orchestrator 1212 may include hardware, software, or some combination thereof.

In at least one embodiment, as shown in FIG. 12, framework layer 1220 may include a job scheduler 1233, a configuration manager 1234, a resource manager 1236, and/or a distributed file system 1238. The framework layer 1220 may include a framework to support software 1232 of software layer 1230 and/or one or more application(s) 1242 of application layer 1240. The software 1232 or application(s) 1242 may respectively include web-based service software or applications, such as those provided by Amazon Web Services, Google Cloud and Microsoft Azure. The framework layer 1220 may be, but is not limited to, a type of free and open-source software web application framework such as Apache Spark™ (hereinafter “Spark”) that may utilize distributed file system 1238 for large-scale data processing (e.g., “big data”). In at least one embodiment, job scheduler 1233 may include a Spark driver to facilitate scheduling of workloads supported by various layers of data center 1200. The configuration manager 1234 may be capable of configuring different layers such as software layer 1230 and framework layer 1220 including Spark and distributed file system 1238 for supporting large-scale data processing. The resource manager 1236 may be capable of managing clustered or grouped computing resources mapped to or allocated for support of distributed file system 1238 and job scheduler 1233. In at least one embodiment, clustered or grouped computing resources may include grouped computing resource 1214 at data center infrastructure layer 1210. The resource manager 1236 may coordinate with resource orchestrator 1212 to manage these mapped or allocated computing resources.

In at least one embodiment, software 1232 included in software layer 1230 may include software used by at least portions of node C.R.s 1216(1)-1216(N), grouped computing resources 1214, and/or distributed file system 1238 of framework layer 1220. One or more types of software may include, but are not limited to, Internet web page search software, e-mail virus scan software, database software, and streaming video content software.

In at least one embodiment, application(s) 1242 included in application layer 1240 may include one or more types of applications used by at least portions of node C.R.s 1216(1)-1216 (N), grouped computing resources 1214, and/or distributed file system 1238 of framework layer 1220. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1234, resource manager 1236, and resource orchestrator 1212 may implement any number and type of self-modifying actions based on any amount and type of data acquired in any technically feasible fashion. Self-modifying actions may relieve a data center operator of data center 1200 from making possibly bad configuration decisions and possibly avoiding underutilized and/or poor performing portions of a data center.

The data center 1200 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1200. In at least one embodiment, trained or deployed machine learning models corresponding to one or more neural networks may be used to infer or predict information using resources described above with respect to the data center 1200 by using weight parameters calculated through one or more training techniques, such as but not limited to those described herein.

In at least one embodiment, the data center 1200 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1100 of FIG. 11—e.g., each device may include similar components, features, and/or functionality of the computing device(s) 1100. In addition, where backend devices (e.g., servers, NAS, etc.) are implemented, the backend devices may be included as part of a data center 1200, an example of which is described in more detail herein with respect to FIG. 12.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1100 described herein with respect to FIG. 11. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### EXAMPLE PARAGRAPHS

A: One or more processors comprising: processing circuitry to: store first vectors corresponding to first queries associated with backends; receive input data representative of a second query; generate, based at least on the input data, a second vector corresponding to the second query; compare the second vector to the first vectors to determine scores associated with the first queries; determine, based at least on the scores, that one or more of the first vectors are related to the second vector; select, based at least on the one or more of the first vectors being related to the second vector, a backend from the backends; and provide at least a portion of the input data to the backend for processing.

B: The one or more processors of paragraph A, wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system that provides one or more cloud gaming applications; a system for performing one or more deep learning operations; a system implemented using an edge device; a system implemented using a robot; a system for performing one or more generative AI operations; a system for performing operations using one or more large language models (LLMs); a system for performing operations using one or more small language models (SLMs); a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; systems implementing one or more multi-modal language models; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.

C: A method comprising: receiving, using a frontend, input data representative of a query; processing, using the frontend, the input data to select a backend from a plurality of backends to route the query, the backend being associated with an artificial intelligence (AI) model capable of processing the query; sending, using the frontend and based at least on selecting the backend, at least a portion of the input data to the backend; receiving, using the frontend and from the backend, output data representative of a response to the query; and causing, using the frontend, output of the response.

D: The method of paragraph C, wherein the processing the input data to select the backend comprises: processing, using the frontend, the input data to determine that the query indicates at least an identifier; determining, using the frontend, that the identifier is associated with the backend; and selecting, using the frontend, the backend based at least on the identifier being associated with the backend.

E: The method of paragraph D, further comprising: storing, using the frontend, data that maps a plurality of identifiers with the plurality of backends, the plurality of identifiers including at least the identifier, wherein the determining that the identifier is associated with the backend is based at least on the data mapping the identifier to the backend.

F: The method of any one of paragraphs C-E, wherein the processing the input data to select the backend comprises: determining, using the frontend, that a previous query included an identifier associated with the backend; processing, using the frontend, the input data to determine that the query does not include one or more identifiers associated the plurality of backends; and selecting the backend based at least on the previous query including the identifier and the query not including the one or more identifiers.

G: The method of any one of paragraphs C-F, wherein the processing the input data to select the backend comprises: generating, using one or more models and based at least on the input data, data representative of a classification associated with the query; and selecting, using the frontend, the backend based at least on the classification being associated with the backend.

H: The method of any one of paragraphs C-G, wherein the processing the input data to select the backend comprises: comparing, using the frontend, the query to a plurality of queries associated with the plurality of backends; determining, based at least on the comparing, that the query is related to one or more queries from the plurality of queries; and selecting, using the frontend, the backend based at least on the one or more queries being associated with the backend.

I: The method of paragraph H, wherein the determining that the query is related to the one or more queries comprises: determining, using the frontend and based at least on the comparing the query to the plurality of queries, scores associated with the plurality of queries; and determining, using the frontend and based at least on the scores, that the query is related to the one or more queries.

J: The method of any one of paragraphs C-I wherein the processing the input data to select the backend comprises: processing, using the frontend, the input data to determine contextual information associated with the query, the contextual information including at least one of a voice, a sentiment, a mood, or an environmental condition; and selecting, using the frontend, the backend based at least on the contextual information.

K: A system comprising: one or more processors to: store first data associated with a plurality of backends, at least a backend of the plurality of backends being associated with an artificial intelligence (AI) agent; receive input data representative of a query; determine, based at least on analyzing the input data with respect to the first data, to route the query to the backend of the plurality of backends; provide the backend with at least a portion of the input data representative of the query; receive, from the backend, output data representative of a response to the query; and provide the response using the output data.

L: The system of paragraph K, wherein: the first data is representative of an order associated with routing queries to the plurality of backends; and the determination to route the query to the backend comprises determining, based at least on the input data, that the order indicates to initially route the query to the backend.

M: The system of either paragraph K or paragraph L, wherein: the first data associates a plurality of identifiers with the plurality of backends; and the determination to route the query to the backend comprises: processing the input data to determine that the query indicates at least an identifier of the plurality of identifiers; and determining, using the first data, that the identifier is associated with the backend.

N: The system of any one of paragraphs K-M, wherein the determination to route the query to the backend comprises: determining that a previous query included an identifier associated with the backend; processing the input data to determine that the query does not include one or more identifiers associated the plurality of backends; and determining to route the query to the backend based at least on the previous query including the identifier and the query not including the one or more identifiers.

O: The system of any one of paragraphs K-N, wherein the determination to route the query to the backend comprises: generating, using one or more models and based at least on the input data, data representative of a classification associated with the query; and selecting the query based at least on the classification being associated with the backend.

P: The system of any one of paragraphs K-O, wherein the determination to route the query to the backend comprises: comparing the query to a plurality of queries associated with the plurality of backends; determining, based at least on the comparing, that the query is related to one or more queries from the plurality of queries; and selecting the backend based at least on the one or more queries being associated with the backend.

Q: The system of paragraph P, wherein the determining the backend comprises: determining, based at least on the comparing the query to the plurality of queries, scores associated with the plurality of queries; and determining, based at least on the scores, that the query is related to the one or more queries.

R: The system of any one of paragraphs K-Q, wherein the comparing the query to the one or more queries comprises: generating, based at least on the input data, a first embedding associated with the query; and comparing the first embedding to one or more second embeddings associated with the one or more queries.

S: The system of any one of paragraphs K-R, wherein the determination to route the query to the backend comprises: processing the input data to determine contextual information associated with the query, the contextual information including at least one of a voice, a sentiment, a mood, or an environmental condition; and determining, using the first data, the backend based at least on the contextual information.

T: The system of any one of paragraphs K-S, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system that provides one or more cloud gaming applications; a system for performing one or more deep learning operations; a system implemented using an edge device; a system implemented using a robot; a system for performing one or more generative AI operations; a system for performing operations using one or more large language models (LLMs); a system for performing operations using one or more small language models (SLMs); a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; systems implementing one or more multi-modal language models; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.

What is claimed is:

1. One or more processors comprising:
processing circuitry to:
store first vectors corresponding to first queries associated with backends;
receive input data representative of a second query;
generate, based at least on the input data, a second vector corresponding to the second query;
compare the second vector to the first vectors to determine scores associated with the first queries;
determine, based at least on the scores, that one or more of the first vectors are related to the second vector;
select, based at least on the one or more of the first vectors being related to the second vector, a backend from the backends; and
provide at least a portion of the input data to the backend for processing.

2. The one or more processors of claim 1, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system that provides one or more cloud gaming applications;
a system for performing one or more deep learning operations;
a system implemented using an edge device;
a system implemented using a robot;
a system for performing one or more generative AI operations;
a system for performing operations using one or more large language models (LLMs);
a system for performing operations using one or more small language models (SLMs);
a system for performing operations using one or more vision language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
systems implementing one or more multi-modal language models;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.

3. A method comprising:
receiving, using a frontend, input data representative of a query;
processing, using the frontend, the input data to select a backend from a plurality of backends to route the query, the backend being associated with an artificial intelligence (AI) model capable of processing the query;
sending, using the frontend and based at least on selecting the backend, at least a portion of the input data to the backend;
receiving, using the frontend and from the backend, output data representative of a response to the query; and
causing, using the frontend, output of the response.

4. The method of claim 3, wherein the processing the input data to select the backend comprises:
processing, using the frontend, the input data to determine that the query indicates at least an identifier;
determining, using the frontend, that the identifier is associated with the backend; and
selecting, using the frontend, the backend based at least on the identifier being associated with the backend.

5. The method of claim 4, further comprising:
storing, using the frontend, data that maps a plurality of identifiers with the plurality of backends, the plurality of identifiers including at least the identifier,
wherein the determining that the identifier is associated with the backend is based at least on the data mapping the identifier to the backend.

6. The method of claim 3, wherein the processing the input data to select the backend comprises:
determining, using the frontend, that a previous query included an identifier associated with the backend;
processing, using the frontend, the input data to determine that the query does not include one or more identifiers associated the plurality of backends; and
selecting the backend based at least on the previous query including the identifier and the query not including the one or more identifiers.

7. The method of claim 3, wherein the processing the input data to select the backend comprises:
generating, using one or more models and based at least on the input data, data representative of a classification associated with the query; and
selecting, using the frontend, the backend based at least on the classification being associated with the backend.

8. The method of claim 3, wherein the processing the input data to select the backend comprises:
comparing, using the frontend, the query to a plurality of queries associated with the plurality of backends;
determining, based at least on the comparing, that the query is related to one or more queries from the plurality of queries; and
selecting, using the frontend, the backend based at least on the one or more queries being associated with the backend.

9. The method of claim 8, wherein the determining that the query is related to the one or more queries comprises:
determining, using the frontend and based at least on the comparing the query to the plurality of queries, scores associated with the plurality of queries; and
determining, using the frontend and based at least on the scores, that the query is related to the one or more queries.

10. The method of claim 3, wherein the processing the input data to select the backend comprises:
processing, using the frontend, the input data to determine contextual information associated with the query, the contextual information including at least one of a voice, a sentiment, a mood, or an environmental condition; and
selecting, using the frontend, the backend based at least on the contextual information.

11. A system comprising:
one or more processors to:
store first data associated with a plurality of backends, at least a backend of the plurality of backends being associated with an artificial intelligence (AI) agent;
receive input data representative of a query;
determine, based at least on analyzing the input data with respect to the first data, to route the query to the backend of the plurality of backends;
provide the backend with at least a portion of the input data representative of the query;
receive, from the backend, output data representative of a response to the query; and
provide the response using the output data.

12. The system of claim 10, wherein:
the first data is representative of an order associated with routing queries to the plurality of backends; and
the determination to route the query to the backend comprises determining, based at least on the input data, that the order indicates to initially route the query to the backend.

13. The system of claim 10, wherein:
the first data associates a plurality of identifiers with the plurality of backends; and
the determination to route the query to the backend comprises:
processing the input data to determine that the query indicates at least an identifier of the plurality of identifiers; and
determining, using the first data, that the identifier is associated with the backend.

14. The system of claim 10, wherein the determination to route the query to the backend comprises:
determining that a previous query included an identifier associated with the backend;
processing the input data to determine that the query does not include one or more identifiers associated the plurality of backends; and
determining to route the query to the backend based at least on the previous query including the identifier and the query not including the one or more identifiers.

15. The system of claim 10, wherein the determination to route the query to the backend comprises:
generating, using one or more models and based at least on the input data, data representative of a classification associated with the query; and
selecting the query based at least on the classification being associated with the backend.

16. The system of claim 10, wherein the determination to route the query to the backend comprises:
comparing the query to a plurality of queries associated with the plurality of backends;
determining, based at least on the comparing, that the query is related to one or more queries from the plurality of queries; and
selecting the backend based at least on the one or more queries being associated with the backend.

17. The system of claim 16, wherein the determining the backend comprises:
determining, based at least on the comparing the query to the plurality of queries, scores associated with the plurality of queries; and
determining, based at least on the scores, that the query is related to the one or more queries.

18. The system of claim 10, wherein the comparing the query to the one or more queries comprises:
generating, based at least on the input data, a first embedding associated with the query; and
comparing the first embedding to one or more second embeddings associated with the one or more queries.

19. The system of claim 10, wherein the determination to route the query to the backend comprises:
processing the input data to determine contextual information associated with the query, the contextual information including at least one of a voice, a sentiment, a mood, or an environmental condition; and
determining, using the first data, the backend based at least on the contextual information.

20. The system of claim 10, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system that provides one or more cloud gaming applications;
a system for performing one or more deep learning operations;
a system implemented using an edge device;
a system implemented using a robot;
a system for performing one or more generative AI operations;
a system for performing operations using one or more large language models (LLMs);
a system for performing operations using one or more small language models (SLMs);
a system for performing operations using one or more vision language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
systems implementing one or more multi-modal language models;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.
